(19) United States
(12) Patent Application Publication
(10) Pub. No.: US 2026/0229398 A1
(43) Pub. Date: Aug. 6, 2026

(54) COIL COMPONENT AND ELECTRONIC/ELECTRIC APPARATUS

(71) Applicant: DELTA ELECTRONICS (JAPAN), INC., Tokyo (JP)

(72) Inventors: Taishi NUMATA, TOKYO (JP); Yamato SAKURAI, TOKYO (JP); Keiichi ARAKI, TOKYO (JP); Kenich IKEDA, TOKYO (JP)

(73) Assignee: DELTA ELECTRONICS (JAPAN), INC., Tokyo (JP)

(21) Appl. No.: 19/150,920

(22) PCT Filed: Dec. 19, 2023
(86) PCT No.: PCT/JP2023/045449

§ 371 Date: Sep. 12, 2025

(30) Foreign Application Priority Data
Jan. 26, 2023 (WO) PCT/JP2023/002527

(51) Int. Cl. H01F 27/29; H01F 27/28; H01F 27/32

(52) U.S. Cl. CPC H01F 27/29; H01F 27/2804; H01F 27/324; H01F 2027/2809

(57) ABSTRACT

A coil component exhibits an excellent overall characteristic when used as an inductance element. The coil component includes first and second coil conductors aligned in a first direction, each of which has a first spiral portion moving around an axis extending along the first direction and away from the axis; a via member electrically connecting the first coil conductor and the second coil conductor; a first terminal member electrically connected to the first coil conductor; and a second terminal member electrically connected to the second coil conductor. The first spiral portion has a first high winding part, and a first low winding part having a number of turns less than that of the first high winding part. A turn in the first low winding part has a portion having a turn width greater than that of a turn in the first high winding part when viewed in the first direction.

### BACKGROUND OF THE INVENTION

### 1. Field of the Invention

The present invention relates to a coil component, and an electronic/electric device, in which the coil component is installed.

### 2. Description of the Related Art

In Patent Document 1, a multilayer seed pattern inductor, which includes a magnetic body and an internal coil portion, is disclosed. In the coil conductor portion of the internal coil portion of the inductor, the coil width is kept constant.

In Patent Document 2, a coil component including an insulating substrate, a coil, a resin wall, and a magnetic base body is disclosed. In the coil component, there is a non-overlapping region where the innermost turn of a first coil conductor pattern on one side of the insulating substrate and the innermost turn of a second coil conductor pattern on the other side of the insulating substrate do not overlap with each other in the thickness direction of the insulating substrate. The sum of the width of the innermost turn of the first coil conductor pattern in this non-overlapping region and the width of the resin wall located inside this innermost turn is narrower than the sum of the width of the turn outer than the innermost turn of the first coil conductor pattern and the width of the resin wall located inside this turn.

### PRIOR ART DOCUMENTS

### Patent Documents

[Patent Document 1] Japanese Patent Publication No. 2016-213443
[Patent Document 1] Japanese Patent Publication No. 2019-16745

### SUMMARY OF THE INVENTION

### Problems to be Solved by the Invention

The inductance value of the coil component disclosed in Patent Document 2 is improved by reducing the dead space in the non-overlapping region of the inductor disclosed in Patent Document 1. In particular, in Patent Document 2, the inductance value is to be improved by narrowing the width of the conductor located in the non-overlapping region. However, resistance would increase in the portion where the conductor width is narrowed. Therefore, as an inductance element, its direct current resistance DCR largely increases. As a result, the coil component disclosed in Patent Document 2, as an inductance element, has a problem of lowered overall characteristic L×Isat/DCR, where L is self-inductance, Isat is direct-current superposition rated current, and DCR is direct-current resistance. In addition, in the first turn of the conductor, the width of the conductor gradually increases toward the second turn of the conductor, and the width of the coil is kept constant from the second turn. Thus, due to the concern in the prior art about the decrease in inductance value resulting from the decrease in magnetic material, it is desirable that the width of the conductor is kept constant by avoiding abrupt or local increase in the width of the conductor, as disclosed in Patent Document 1 and Patent Document 2.

An object of the present invention is to provide a coil component, which has a spiral-type conductor and has an excellent overall characteristic as an inductance element. In addition, another object of the present invention is to provide an electronic/electric device, which is installed therein a coil component.

### Means to Solve the Problems

The present invention provided to solve the above problems is a coil component. In an embodiment, the coil component includes a coil member and terminal members. The coil member includes a coil conductor portion containing a first spiral portion, which is spiral-shaped when viewed in a first direction. The terminal members are electrically connected to two end parts of the coil conductor portion, respectively. When viewed in the first direction, the first spiral portion includes a widening portion, so that the width of the first spiral portion increases and then decreases along the spiral direction of the first spiral portion.

The coil component may further include a main body portion containing a magnetic powder. In this case, the coil member further includes a coil insulator portion on a surface of the coil conductor portion. The coil conductor portion further includes a second spiral portion having a spiral shape that is spiral-shaped when viewed in the first direction, and a via member electrically connected to the first spiral portion and the second spiral portion. The coil insulator portion is disposed between the first spiral portion and the second spiral portion. For enabling contact of one end part of the first spiral portion with one end part of the second spiral portion in the first direction, the via member may be disposed between the one end part of the first spiral portion and the one end part of the second spiral portion.

In the coil component, when viewed in the first direction, an inner circumferential edge of the first spiral portion comprises an inner curved portion having a radius of curvature, which decreases and then increases. An outer circumferential edge of the first spiral portion comprises an outer curved portion having a radius of curvature, which decreases and then increases. The outer curved portion is opposite to the inner curved portion with the first spiral portion clamped in between. In a case, there are four or more sets of the inner curved portion and the outer curved portion, and a ratio Roa/Ria of an average Roa of minimum radii of curvature Rwo of the outer curved portions to an average Ria of minimum radii of curvature Rwi of the inner curved portions is preferably from 0.80 to 1.30.

In the coil component, when viewed in the first direction, the inner circumferential edge of the first spiral portion comprises an inner arc portion, which is shaped approximately as an arc having a radius Ri and a central angle of 90°. The outer circumferential edge of the first spiral portion comprises an outer arc portion, which is shaped approximately as an arc having a radius Ro and a central angle of 90°, and a connecting portion, which is shaped approximately as an arc having a radius larger than the radius Ro or a straight line. The number of sets of the inner arc portion and the outer arc portion and the number of the connecting portions are respectively four. In a case, a ratio RoA/RiA of an average RoA of radii Ro of the outer arc portions to an average RiA of radii Ri of the inner arc portions is preferably from 0.80 to 1.30.

In the coil component, when viewed in the first direction, the spiral direction of the first spiral portion and the spiral direction of the second spiral portion may be the same.

In the coil component, the first spiral portion has a plurality of turns when viewed in the first direction, and includes a first region having a relatively large number of turns and a second region having a relatively small number of turns. There may be n turns (n is a natural number of 2 or more) in the first region. In this case, regarding the turns disposed in the first region, the turn located in the innermost side of the first region is defined as a first turn, and the turn located in the outermost side of the first region is defined as an nth turn. The turns located in the first region are defined so as to be distinguishable from each other. When j is a natural number equal to or smaller than n−1: (1) an outer circumferential edge of the jth turn includes a jth-turn outer curved portion, which has a decreasing and then increasing radius of curvature; (2) an inner circumferential edge of the (j+1)th turn, which is opposite to the outer circumferential edge of the jth turn, and includes a (j+1)th-turn inner curved portion, which has a decreasing and then increasing radius of curvature; and (3) there may exist at least one j satisfying a condition of Rjwo/Rj+1wi≥0.9, where Rwo is a minimum radius of curvature of the jth-turn outer curved portion, and Rj+1wi is a minimum radius of curvature of the inner curved portion of the (j+1)th-turn inner curved portion.

In the coil component, the first spiral portion has a plurality of turns when viewed in the first direction, and includes a first region having a relatively large number of turns and a second region having a relatively small number of turns. There may be n turns (n is a natural number of 2 or more) in the first region. In this case, regarding the turns disposed in the first region, the turn located in the innermost side of the first region is defined as a first turn, and the turn located in the outermost side of the first region is defined as an nth turn. The turns located in the first region are defined so as to be distinguishable from each other. When k is a natural number equal to or smaller than n: (i) an outer circumferential edge of the kth turn includes a kth-turn outer curved portion, which has a decreasing and then increasing radius of curvature; (ii) an inner circumferential edge of the kth turn includes a kth-turn outer curved portion, which has a decreasing and then increasing radius of curvature; and (iii) each k satisfies a condition of Rkwo/Rkwi is from 0.8 to 1.2, where Rkwo is a minimum radius of curvature of the kth-turn outer curved portion, and Rkwi is a minimum radius of curvature of the kth-turn inner curved portion.

In the coil component, when viewed in the first direction, the first spiral portion has a plurality of turns, and includes a first region having a relatively large number of turns and a second region having a relatively small number of turns. Each of the first region and the second region may comprise the widening portion.

In the coil component, when viewed in the first direction, the first spiral portion has a plurality of turns, and includes a first region having a relatively large number of turns and a second region having a relatively small number of turns. Each of the first region and the second region includes the widening portion. When viewed in the first direction, the second spiral portion has a second specified number of turns, and includes a third region having a relatively large number of turns, and a fourth region having a relatively small number of turns. Each of the third region and the fourth region may comprise the widening portion.

In the coil component, a turn of the first spiral portion, which is immediately adjacent to the one end part via a gap, may comprise the widening portion to accommodate at least a portion of the one end part.

In the coil component, a turn of the first spiral portion, which is immediately adjacent to the one end part via a gap, may comprise the widening portion disposed at a position just passing the one end part in the direction opposite to the spiral direction, which starts from the one end part.

In the coil component, a turn of the first spiral portion, which is immediately adjacent to an outermost turn of the first spiral portion via a gap, may comprise the widening portion disposed at a position just passing the outermost turn in the spiral direction, which starts from the one end part.

In the coil component, when viewed in the first direction, the first spiral portion has a plurality of turns, and includes a first region having a relatively large number of turns and a second region having a relatively small number of turns. When viewed in the first direction, the second spiral portion has a second specified number of turns, and may include a third region having a relatively large number of turns, and a fourth region having a relatively small number of turns. In this case, a gap between turns of the first spiral portion and a gap between turns of the second spiral portion may sandwich the coil insulator portion and form an opposing portion. In the second region and the fourth region, the gaps may sandwich the coil insulator portion and intersect.

In the coil component, when viewed in the first direction, an outer shape of the main body portion is approximately a rectangle, and a sum of lengths of the first spiral portion on two diagonals of the rectangle may be greater than a sum of lengths of the first spiral portion on two line segments, each connecting midpoints of two opposite sides of the rectangle.

In the coil component, when viewed in the first direction, an outer shape of the main body portion is approximately a rectangle, and a midpoint of the first spiral portion on each of two diagonals of the rectangle may be disposed closer to a vertex of the rectangle than a midpoint between an intersection point of the two diagonals and the vertex of the rectangle is.

In the coil component, when viewed in the first direction, when an outer shape of the first spiral portion is approximately a rectangle, at least one of lengths of the first spiral portion on two diagonals of the rectangle may be greater than at least one of lengths of the first spiral portion on two line segments, each connecting midpoints of sides of the rectangle.

In this case, the coil component further includes a main body portion, which is approximately shaped as a rectangle when viewed in the first direction and comprises magnetic powder. When viewed in the first direction, two diagonals of the approximate rectangle of the outermost circumferential edge of the first spiral portion may extend along with two diagonals of the approximate rectangle of the outer shape of the main body portion.

A further or another aspect of the present invention is directed to an electronic/electric device. In the electronic/electric device, the coil component is installed, and the coil component is connected to a board via the terminal members. Examples of the electronic/electric device include a power supply equipped with a power switching circuit, a voltage step-up circuit, a smoothing circuit, etc., and a small portable communication device. The electronic/electric device according to the present invention has an excellent overall characteristic when used as an inductance element as a result of including the above-mentioned coil component.

### Effect of the Invention

According to the present invention, a coil component has an excellent overall characteristic when used as an inductance element. When the coil component is installed in an electronic/electric device, it can be expected to improve the performance of the electronic or electric device with reduced dimensions. According to The present invention, an electronic/electric device, in which the coil component is installed, is also provided.

### BRIEF DESCRIPTION OF THE DRAWINGS

FIG. 1 is a perspective view schematically illustrating a concept of a shape of a coil component according to an embodiment of the present invention.

FIG. 2 is a schematic diagram illustrating a structure of two spiral portions included in a coil component according to an embodiment of the present invention.

FIG. 3 is an XY plan view illustrating a structure of a first spiral portion included in a coil component according to an embodiment of the present invention.

FIG. 4 is an XY plan view illustrating a structure of a second spiral portion included in a coil component according to an embodiment of the present invention.

FIG. 5 is an XY plan view illustrating a specific structural feature (first feature) of a first spiral portion included in a coil component according to an embodiment of the present invention.

FIG. 6 is an XY plan view illustrating a specific structural feature (second feature) of a first spiral portion included in a coil component according to an embodiment of the present invention.

FIG. 7 is an XY plan view illustrating specific structural features (third feature and fourth feature) of a first spiral portion included in a coil component according to an embodiment of the present invention.

FIG. 8 is an XY plan view illustrating specific structural features (fifth feature and tenth feature) of a first spiral portion and a second spiral portion included in a coil component according to an embodiment of the present invention.

FIG. 9 is an XY plan view illustrating specific structural features (sixth feature and tenth feature) of a first spiral portion and a second spiral portion included in a coil component according to an embodiment of the present invention.

FIG. 10 is an XY plan view illustrating specific structural features (seventh feature to ninth feature) of a first spiral portion included in a coil component according to an embodiment of the present invention.

FIG. 11 is an XY plan view illustrating a specific structural feature (eleventh feature) of a first spiral portion included in a coil component according to an embodiment of the present invention.

FIG. 12A is an XY plan view illustrating a specific structural feature (twelfth feature) of a first spiral portion included in a coil component according to an embodiment of the present invention.

FIG. 12B is a first XY plan view illustrating a specific structural feature (thirteenth feature) of a first spiral portion included in a coil component according to an embodiment of the present invention.

FIG. 12C is a second XY plan view illustrating a specific structural feature (thirteenth feature) of a first spiral portion included in a coil component according to an embodiment of the present invention.

FIG. 12D is an XY plan view illustrating a specific structural feature of a first spiral portion included in a coil component in a comparative example.

FIG. 12E is an XY plan view illustrating a specific structural feature (fourteenth feature) of a first spiral portion included in a coil component according to an embodiment of the present invention.

FIG. 12F is an XY plan view illustrating a specific structural feature (fifteenth feature) of a first spiral portion included in a coil component according to an embodiment of the present invention.

FIG. 13 is an XY plan view illustrating structures of a first spiral portion and a second spiral portion included in a coil component in Embodiment 1.

FIG. 14 is an XY plan view illustrating structures of a first spiral portion and a second spiral portion included in a coil component in Embodiment 2.

FIG. 15 is an XY plan view illustrating structures of a first spiral portion and a second spiral portion included in a coil component in Embodiment 3.

FIG. 16 is an XY plan view illustrating structures of a first spiral portion and a second spiral portion included in a coil component in Embodiment 4.

FIG. 17 is an XY plan view illustrating structures of a first spiral portion and a second spiral portion included in a coil component in Embodiment 5.

FIG. 18A is an XY plan view illustrating structures of a first spiral portion and a second spiral portion included in a coil component in Embodiment 6.

FIG. 18B is an XY plan view illustrating structures of a first spiral portion and a second spiral portion included in a coil component in Embodiment 7.

FIG. 18C is an XY plan view illustrating structures of a first spiral portion and a second spiral portion included in a coil component in Embodiment 8.

FIG. 19 is an XY plan view illustrating structures of a first spiral portion and a second spiral portion included in a coil component in a comparative example.

FIG. 20A is a graph showing compared results of embodiments and a comparative example.

FIG. 20B is a graph showing compared results of embodiments and a comparative example.

FIG. 20C is a graph showing results of embodiments.

FIG. 20D is a graph showing results of embodiments.

FIG. 20E is a graph showing results of embodiments.

FIG. 20F is a graph showing results of embodiments.

FIG. 20G is a graph showing results of embodiments.

FIG. 21 is an XY plan view illustrating a structure of a first spiral portion included in a coil component according to another example of an embodiment of the present invention.

FIG. 22 is an XY plan view illustrating a structure of a first spiral portion included in a coil component according to further example of an embodiment of the present invention.

### DETAILED DESCRIPTION OF BEST MODE EMBODIMENTS FOR IMPLEMENTING THE INVENTION

Below, embodiments according to the present invention will be described in detail with reference to the drawings.

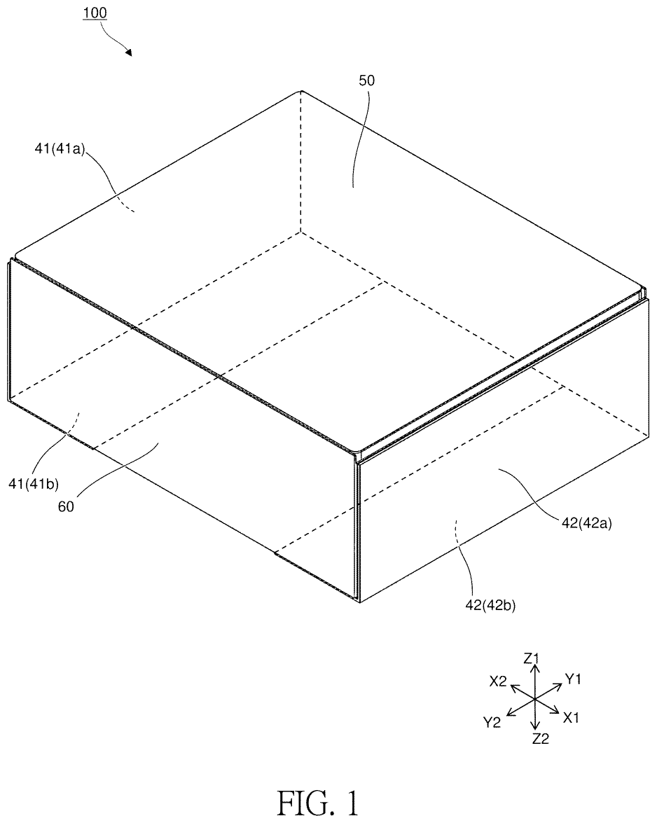

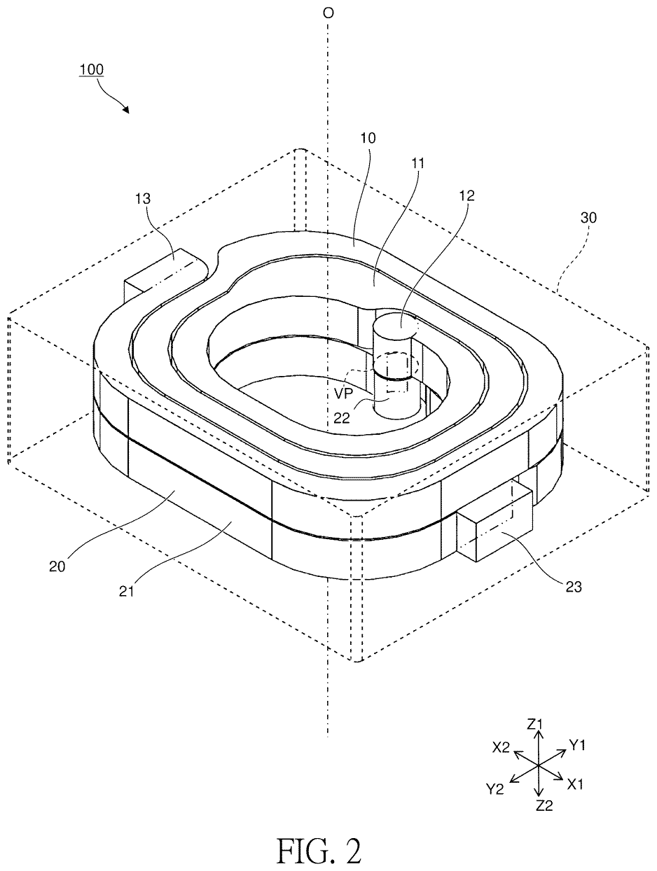

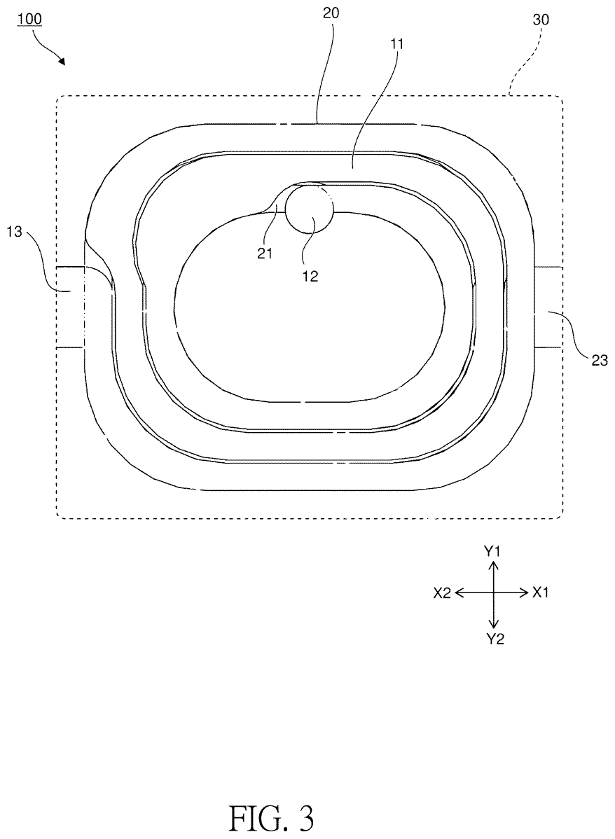

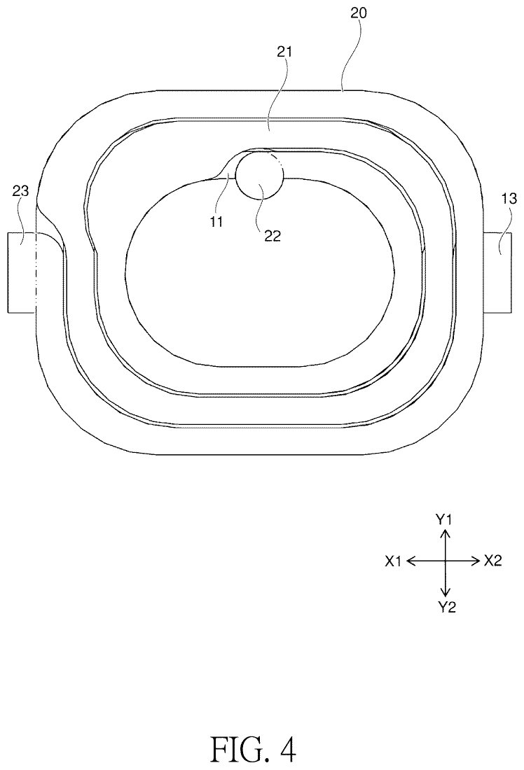

FIG. 1 is a perspective view schematically illustrating a concept of a shape of a coil component according to an embodiment of the present invention. FIG. 2 is a schematic diagram illustrating a structure of two spiral portions included in a coil component according to an embodiment of the present invention. In FIG. 2, for readily understanding, the coil conductor portion including the two spiral portions is drawn with a solid line while the main body portion is drawn with a dashed line, and the other components are omitted from the drawing. FIG. 3 is an XY plan view illustrating a structure of a first spiral portion included in a coil component according to an embodiment of the present invention. Likewise, in FIG. 3, for readily understanding, the coil conductor portion including the two spiral portions is drawn with a solid line while the main body portion is drawn with a dashed line, and the other components are omitted from the drawing. FIG. 4 is an XY plan view illustrating a structure of a second spiral portion included in a coil component according to an embodiment of the present invention. It is to be noted that FIG. 2 is a perspective view, FIG. 3 is a view seen from the Z1 side in the Z1-Z2 direction, and FIG. 4 only shows the coil conductor portion seen from the Z2 side in the Z1-Z2 direction.

### (Overall Structure)

A coil component 100 according to one embodiment of the present invention includes a coil member 10 having a coil conductor portion 20, a main body portion 30, a first terminal member 41, a second terminal member 42, and outer covers 50 and 60.

(coil)

As shown in FIG. 2 and FIG. 3, the coil member 10 has a coil conductor portion 20 including a first spiral portion 11. The first spiral portion 11 is shaped as a spiral extending from an end part 12 at an inner side thereof toward another end part 13 at an outer side thereof around an axis O in parallel to a first direction (Z1-Z2 direction), and moves away from the axis O. As shown in FIG. 2, the first spiral portion 11, when viewed from the Z1 side in the Z1-Z2 direction, is arranged with spiral-shaped turns, which extend clockwise from the end part 12 toward the end part 13, and moves away from the axis O. In the present disclosure, the “spiral direction” of the spiral portion means the direction from the end part at the inner side toward the end part at the outer side. In this embodiment, the spiral direction is any of the in-plane directions of a plane that has the axis O along the first direction (Z1-Z2 direction) as a normal line. Among the in-plane directions perpendicular to this first direction, as shown in FIGS. 2-4, the direction (X1-X2 direction), in which the end part 13 of the first spiral portion 11 and an end part 23 of the second spiral portion 21 are aligned, is defined as a second direction, and the direction (Y1-Y2 direction) perpendicular to the first direction and the second direction is defined as a third direction.

The conductor (conductive material) used for forming the coil conductor portion 20 is not limited as long as it has appropriate conductivity. Specific examples of the conductor include copper, copper alloys, aluminum, and aluminum alloys. The coil conductor portion 20 can be manufactured by any suitable a film forming technique, for example, plating. The coil member 10 further includes a coil insulator portion (not shown) on a surface of the coil conductor portion 20. With the coil insulator portion, insulation between adjacent conductors (between surfaces of the conductors facing each other) of the coil conductor portion 20 can be ensured. The coil insulator portion may be made of, for example, a resin material. No coil insulator portion is provided at the two end parts (end part 13 and end part 23) of the coil conductor portion 20 so that the coil member 10 can be electrically connected to another member at the end parts.

As shown in FIGS. 2 and 4, the coil conductor portion 20 has a second spiral portion 21 disposed in alignment with the first spiral portion 11 in the first direction. Around an axis O extending along the first direction (Z1-Z2 direction), the second spiral portion 21 has a spiral shape extending from an end part 22, which is an inner side end part of the second spiral portion 21, toward another end part 23, which is an outer side end part of the second spiral portion 21, and moving away from the axis O. In the second spiral portion 21, when viewed from the Z1 side in the Z1-Z2 direction, turns are arranged with a spiral shape rotating contrary to the first spiral portion 11 (counterclockwise in FIG. 2) and moving away from the axis O.

The end part 12 of the first spiral portion 11 and the end part 22 of the second spiral portion 21 are electrically connected through a via member VP. The via member VP may be made of the same conductor as the coil conductor portion 20. In a specific example, the via member VP is made of the same material as the coil conductor portion 20 and is manufactured at the same time as the coil conductor portion 20. In this case, the via member VP is integrated with the end part 12 of the first spiral portion 11 and the end part 22 of the second spiral portion 21.

### (First Feature)

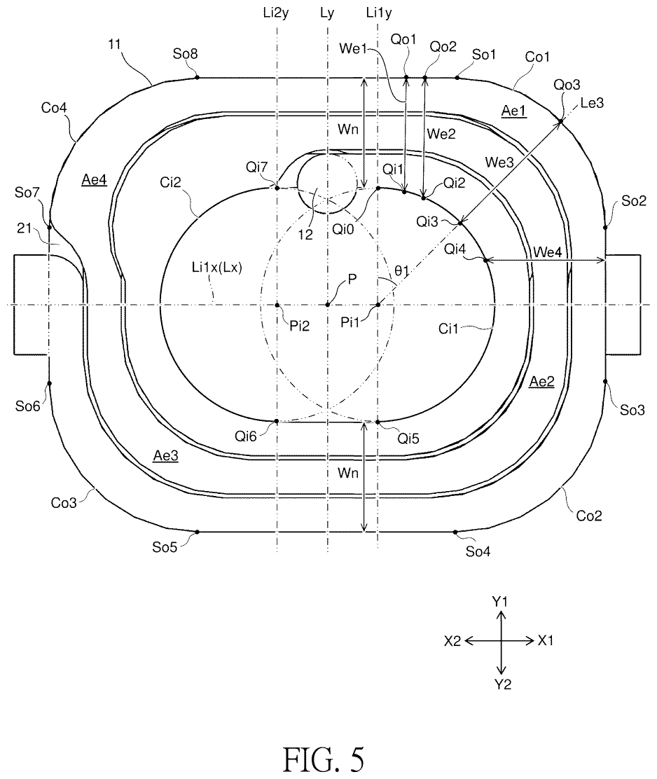

FIG. 5 is an XY plan view illustrating a specific structural feature (first feature) of a first spiral portion included in a coil component according to an embodiment of the present invention. As viewed in the first direction (Z1-Z2 direction), the first spiral portion 11 includes a widening portion, in which the width of the first spiral portion 11 increases and then decreases along the spiral direction of the first spiral portion 11.

In this disclosure, the expression “width of conductor (turn)” is defined as the distance between an arbitrary point on the inner circumference of the conductor (turn) and a point on the outer circumference of the conductor (turn), which is closest to the arbitrary point, when viewed in the first direction (Z1-Z2 direction). The expression “width of first spiral portion 11” is defined as, when viewed in the first direction (Z1-Z2 direction), the distance between an arbitrary point on the inner circumference of the conductor (turn), which is disposed at the innermost circumference, and a point on the outer circumference of the conductor (turn), which is disposed at the outermost circumference and closest to the arbitrary point. Therefore, the width of the first spiral portion 11 includes each gap between two turns, which are aligned in a radial direction of the spiral. The width of the second spiral portion 21 is defined in a similar manner.

As shown in FIG. 5, the inner circumference of the first spiral portion 11 has an approximate shape of a rounded rectangle (stadium) extending in the X1-X2 direction (second direction). Specifically, the shape of the inner circumference approximates to a rounded rectangle consisting of first semicircle arc Ci1, which is disposed at the X1 side in the X1-X2 direction and centered at a point Pi1; a second semicircle arc Ci2, which is disposed at the X2 side in the X1-X2 direction and centered at a point Pi2; a line segment Qi0Qi7, which links an end point Qi0 of the first semicircle arc Ci1 and an end point Qi7 of the second semicircle arc Ci2; and another line segment Qi5Qi6, which links another end point Qi5 of the first semicircle arc Ci1 and another end point Qi6 of the second semicircle arc Ci2. The points Pi1 and Pi2 are disposed on a virtual line Li1x extending along the X1-X2 direction (second direction). When viewed in the Z1-Z2 direction, the virtual line Li1x overlaps with the virtual line Lx, which passes through a center of the coil conductor portion 20 in the Y1-Y2 direction, and intersects with the axis O at a point P.

Furthermore, as shown in FIG. 5, the outer circumferential edge of the first spiral portion 11 has a shape approximating a rectangle with rounded vertices (rounded rectangle). Specifically, the outer circumferential edge consists of an arc of a quarter circle Co1 located on the X1 side and the Y1 side; an arc of a quarter circle Co2 located on the X1 side and the Y2 side; an arc of a quarter circle Co3 located on the X2 side and the Y2 side; an arc of a quarter circle Co4 located on the X2 side and the Y1 side; a line segment So1So8 linking a point So1, which is an end point of the quarter circle Co1, and a point So8, which is an end point of the quarter circle Co4; a line segment So2So3 linking a point So2, which is another end point of the quarter circle circle Co1, and a point So3, which is an end point of the quarter circle circle Co2; a line segment So4So5 linking a point So4, which is another end point of the quarter circle Co2, and a point So5, which is an end point of the quarter circle Co3; and a line segment So6So7 linking a point So6, which is another end point of the quarter circle Co3, and a point So7, which is another end point of the quarter circle Co4.

A virtual line Lily that passes through a point Pi1 and extends in the Y1-Y2 direction (third direction) has a length crossing the Y1 side in the Y1-Y2 direction of the first spiral portion 11 equal to a width Wn of the first spiral portion 11, in which the virtual line Lily intersects with the inner circumferential edge at a point Qi0. A point Qi1, which is away from the point Qi0 along the spiral direction (X1 side in X1-X2 direction), is located on the semicircle Ci1. A point Qo1 on the outer circumferential edge, which is closest to the point Qi1, is on the line segment So8So1. Therefore, a width We1 of the first spiral portion 11 at the point Qi1 is equal to a distance between the point Qi1 and the line segment So8So1. As can be seen from the allocation of the points shown in FIG. 5, the width We1 is greater than width Wn.

Likewise, a point Qi2, which is away from the point Qi1 along the spiral direction (X1 side in X1-X2 direction), is located on the semicircle Ci1. A point Qo2 on the outer circumferential edge, which is closest to the point Qi2, is on the line segment So8So1. Therefore, a width We2 of the first spiral portion 11 at the point Qi2 is equal to a distance between the point Qi2 and the line segment So8So1. As can be seen from the allocation of the points shown in FIG. 5, the width We2 is greater than width We1. In this way, the width of the first spiral portion 11 increases from the point Qi0 toward a point Qi3, where a virtual line Le3 intersects with the inner circumferential edge. The virtual line Le3 has the point Pi1 serving as an end point and inclines from the virtual line Lily at an angle θ1 of 45°.

Afterwards, with the point Pi1 being as one end point, a width We4 of the first spiral portion 11 at a point Qi4, which is away from the point Qi3 along the spiral direction, becomes narrower than the width We3 of the first spiral portion 11 at the point Qi3. This tendency of narrowing width is kept in a region enclosed by a virtual line Lx and the virtual line Le3, wherein the virtual line Lx passes through the point Pi1 along the X1-X2 direction (second direction).

In this way, the width of the first spiral portion 11 increases along the spiral direction from the point Qi0 where the inner circumferential edge of the first spiral portion 11 intersects with the virtual line Lily, toward the point Qi3, and subsequently from the point Qi3 toward the point where the inner circumferential edge of the first spiral portion 11 intersects with the virtual line Lx, becomes narrow.

Therefore, in the first spiral portion 11, the region on the X1 side and the Y1 side, which is surrounded by the virtual lines Lily and Lx, forms a widening portion, in which the width of the first spiral portion 11 increases and then decreases along the spiral direction. Hereinafter, this region is referred to as a first widening portion Ae1.

Furthermore, in the spiral direction, if a width crossing the first spiral section 11 with a virtual line linking the point Pi1 and a point on the inner circumference is realized, a range on the X1 side and the Y2 side, which is surrounded by the virtual line Lx and the virtual line Lily, forms a widening portion. This region is referred to as a second widening portion Ae2.

The general shape of the first spiral portion 11 as viewed in the first direction (Z1-Z2 direction) has four-fold rotational symmetry centered on the point P. A region surrounded by a virtual line Lily, which passes through a point Pi2 and extends in the Y1-Y2 direction (third direction), and the virtual line Lx, and located on the X2 side and the Y2 side, forms another widening portion. This region is referred to as a third widening portion Ae3. As shown in FIG. 5, in a range surrounded by the virtual line Lx and a virtual line Ly, which passes through the point P and extends in the Y1-Y2 direction (third direction), and located on the X2 side and the Y1 side, the turn that is supposed to be the second turn from the inner side of the first widening portion Ae1 side becomes the innermost turn and connects the third widening portion Ae3. For this reason, the point Qi0 is supposed to be the starting point of the inner circumferential edge on the X2 side in the X1-X2 direction in the first widening portion Ae, but the width of the first spiral portion 11 in the region between the virtual line Lily and the virtual line Ly changes. Therefore, the region surrounded by the virtual lines Lx and Ly on the X2 side and the Y1 side becomes a widening portion. Hereinafter, this region is referred to as a fourth widening portion Ae4. To describe the feature of the fourth widening portion Ae4 in an alternative way, the width of the innermost turn in the fourth widening portion Ae4 narrows to avoid the end 12, and renders the second turn from the inner circumference of the first widening portion Ae1. Therefore, the fourth widening portion Ae4 differs from other widening portions in that the virtual line Ly is a boundary line.

As described above, the first spiral portion 11 of the coil conductor portion 20 of the coil component 100 in this embodiment has four widening portions (first widening portion Ae1 to fourth widening portion Ae4). In the widening portions, the width of the conductor is wider than that in other portions, so the resistance value of the first spiral portion 11 is relatively lower. Therefore, in the coil component 100, in which the first spiral portion 11 has widening portions, the DCR is lowered and the overall characteristic (L×Isat/DCR) is improved.

### (Second Feature)

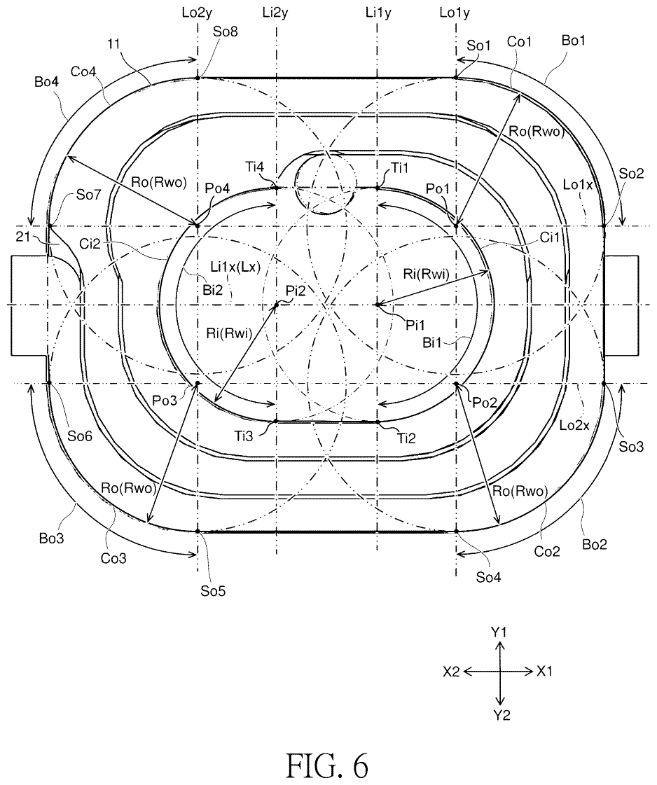

FIG. 6 is an XY plan view illustrating a specific structural feature (second feature) of the first spiral portion included in the coil component according to an embodiment of the present invention.

The first spiral portion 11 has a second feature which will be described hereinafter. Regarding the second feature, the inner circumferential edge of the first spiral portion 11 has an inner curved part, in which the radius of curvature decreases and then increases when viewed in the first direction (Z1-Z2 direction). In addition, the outer circumferential edge of the first spiral portion 11 has an outer curved part, in which the radius of curvature decreases and then increases. Furthermore, the outer curved part is opposite to the inner curved part via the first spiral portion 11. There are four or more sets of such inner and outer curved parts. Each of the inner curved parts and each of the outer curved parts has one minimum radius of curvature. Furthermore, a ratio Roa/Ria is from 0.80 to 1.30, where Ria is an average of the minimum radius of curvature Rwi of the inner curved parts, and Roa is an average of the minimum radius of curvature Rwo of the outner curved parts.

As shown in FIG. 6, the inner circumferential edge of the first spiral portion 11 approximately consists of an arc of a semicircle Ci1 centered at the point Pi1, an arc of a semicircle Ci2 centered at the point Pi2, and two line segments (line segment Ti1Ti4 and line segment Ti2Ti3) linking end points of the adjacent semicircle arcs. Since the radii of curvature of the points on the two line segments are infinite and the radii of the semicircles Ci1 and Ci2 are finite (radius Ri), at a point Ti1, the radius of curvature of the inner circumferential edge decreases in the spiral direction (X1 side in X1-X2 direction). Furthermore, the radius of curvature of the inner circumferential edge is constant from the point Ti1 to a point Ti2. At the point Ti2, the radius of curvature of the inner circumferential edge increases in the spiral direction (X2 side in X1-X2 direction) and becomes infinite. Therefore, the radius of curvature of the arc, which is included in the inner circumferential edge of the first spiral portion 11 and shaped approximately as the semicircle Ci1, decreases and then increases. Hereinafter, this portion is referred to as a first inner curved portion Bi1.

Likewise, at a point Ti3, the radius of curvature decreases in the spiral direction (X2 side in X1-X2 direction). Afterwards, the radius of curvature of the inner circumferential edge is constant up to a point Ti4. Then, at the point Ti4, the radius of curvature of the inner circumferential edge increases in the spiral direction, becoming infinite. Therefore, the radius of curvature of the arc, which is included in the inner circumferential edge of the first spiral portion 11 and shaped approximately as the semicircle Ci2, decreases and then increases. Hereinafter, this portion is referred to as a second inner curved portion Bi2.

As shown in FIG. 6, the outer circumferential edge of the first spiral portion 11 has an approximate shape of a rectangle with rounded vertices (rounded rectangle). Specifically, the outer circumferential edge approximately consists of an arc of a quarter circle Co1 located on the X1 side and the Y1 side and centered at the point Po1; an arc of a quarter circle Co2 located on the X1 side and the Y2 side and centered at the point Po2; an arc of a quarter circle Co3 located on the X2 side and the Y2 side and centered at the point Po3; an arc of a quarter circle Co4 located on the X2 side and the Y1 side and centered at the point Po4; and four line segments (line segment So1So8, line segment So2So3, line segment So4So5, and line segment So6So7) linking ends of adjacent arcs of the four quarter circle Co1-C04. The radius of each of the four quarter circles Co1-Co4 is Ro. The points Po1 and Po2 are located on a virtual line Lo1y along the Y1-Y2 direction, the points Po2 and Po3 are located on a virtual line Lo2x along the X1-X2 direction (second direction), the points Po3 and Po4 are located on a virtual line Lo2y along the Y1-Y2 direction (third direction), and the points Po4 and Po1 are located on a virtual line Lo1x along the X1-X2 direction (second direction). Two of the four virtual lines extend along the X1-X2 direction (second direction), and the other two extend along the Y1-Y2 direction (third direction).

At a point So1, the radius of curvature decreases in the spiral direction (X1 side in X1-X2 direction). The radius of curvature of the outer circumferential edge is constant from the point So1 to a point So2. At the point So2, the radius of curvature of the outer circumferential edge increases in the spiral direction (Y2 side in Y1-Y2 direction) and becomes infinite. Therefore, the radius of curvature of the outer circumferential edge of the first spiral portion 11 decreases and then increases in the portion that approximates the arc of the quarter circle Co1. Hereinafter, this portion will be referred to as a second outer curved portion Bo1.

Likewise, at a point So3, the radius of curvature decreases in the spiral direction (Y2 side in Y1-Y2 direction). Thereafter, the radius of curvature of the outer circumferential edge is constant from the point So3 to a point So4. At the point So4, the radius of curvature of the outer circumferential edge increases in the spiral direction and becomes infinite. Therefore, the radius of curvature of the outer circumferential edge of the first spiral portion 11 decreases and then increases in the portion that approximates the arc of the quarter circle Co2. Hereinafter, this portion is referred to as a second outer curved portion Bo2. Similarly, the outer circumferential edge of the first spiral portion 11 has a third outer curved portion Bo3 in the portion that approximates the arc of the quarter circle Co3 with points So5 and So6 as its end points, and a fourth outer curved portion Bo4 in a portion that approximates the arc of the quarter circle Co4 with points So7 and So8 as its end points.

The first outer curved portion Bo1 is opposite to the first inner curved portion Bi1 with the first spiral portion 11 clamped in between, the second outer curved portion Bo2 is opposite to the first inner curved portion Bi1 with the first spiral portion 11 clamped in between, the third outer curved portion Bo3 is opposite to the second inner curved portion Bi2 with the first spiral portion 11 clamped in between, and the fourth outer curved portion Bo4 is opposite to the second inner curved portion Bi2 with the first spiral portion 11 clamped in between. Therefore, the first spiral portion 11 has four sets of inner and outer curved portions (the set of the first inner curved portion Bi1 and the first outer curved portion Bo1 to the set of the second inner curved portion Bi2 and the fourth outer curved portion Bo4).

Since the position of the first inner curved portion Bi1 overlaps the arc of the semicircle Ci1, the minimum radius of curvature Rwi of the first inner curved portion Bi1 is equal to the radius Ri of the semicircle Ci1. Likewise, the minimum radius of curvature Rwi of the second inner curved portion Bi2 is equal to the radius Ri of the semicircle Ci1. Therefore, in this embodiment, the average Ria of the minimum radii of curvature Rwi of the inner curved portions (first inner curved portion Bi1 and second inner curved portion Bi2) is equal to the radius Ri.

Since the position of the first outer curved portion Bo1 overlaps the arc of the quarter circle Co1, the minimum radius of curvature Rwo of the first outer curved portion Bo1 is equal to the radius Ro of the quarter circle Co1. Likewise, the minimum radius of curvature Rwo of the second outer curved portion Bo2 is equal to the radius Ro of the quarter circle Co2, the minimum radius of curvature Rwo of the third outer curved portion Bo3 is equal to the radius Ro of the quarter circle Co3, and the minimum radius of curvature Rwo of the fourth outer curved portion Bo4 is equal to the radius Ro of the quarter circle Co4. Therefore, in this embodiment, the average Roa of the minimum radii of curvature Rwo of the outer curved portions (first outer curved portion Bo1 to fourth outer curved portion Bo4) is equal to the radius Ro.

The first spiral portion 11 preferably has a ratio Roa/Ria of the average Roa to the average Ria of 0.30 or more and 2.50 or less. When the ratio Roa/Ria is 0.30 or more, the DCR can be further reduced while maintaining the inductance as much as possible. Furthermore, when the ratio Roa/Ria is 2.50 or less, it becomes easier to create widening portions in the first spiral portion 11. Therefore, when the ratio Roa/Ria is 0.30 or more and 2.50 or less, a better overall characteristic (L×Isat/DCR) of the coil component 100 can be obtained stably. In consideration of improvement of the overall characteristic (L×Isat/DCR) of the coil component 100, it is preferable that the ratio Roa/Ria is ranged between 0.60 and 1.60, and it is particularly preferable that a range between 0.80 and 1.30 is applied.

In consideration of reliable fulfillment of the overall characteristic (L×Isat/DCR) of a satisfactory coil component 100, it is preferable that the ratio Rwo/Rwi of the minimum radius of curvature Rwo to the minimum radius of curvature Rwi of each of the four sets of inner and outer curved portions of the first spiral portion 11 is ranged between 0.30 and 2.50, more preferably between 0.60 and 1.60, and particularly preferably between 0.80 and 1.30.

### (Third Feature)

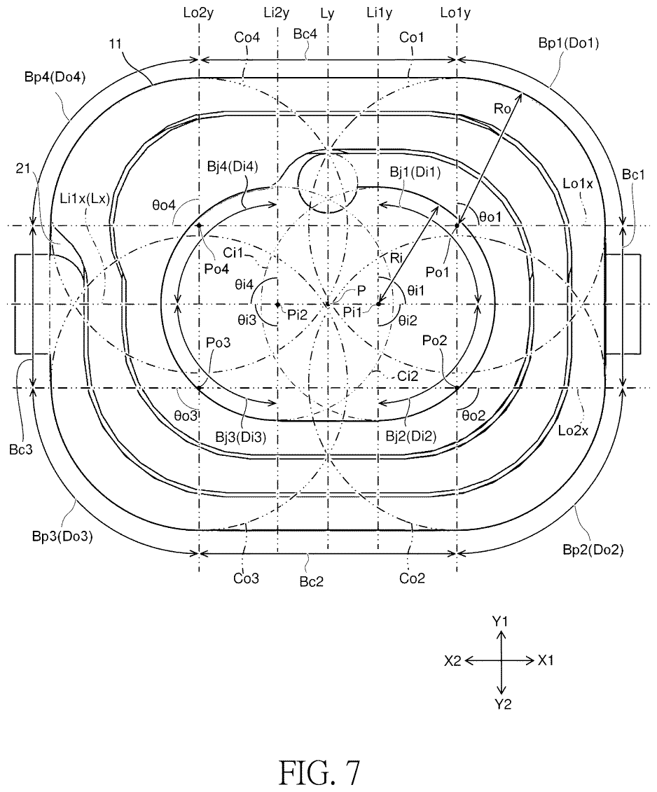

FIG. 7 is an XY plan view illustrating specific structural features (third feature and fourth feature) of the first spiral portion included in the coil component according to an embodiment of the present invention.

The first spiral portion 11 has a third feature which will be described hereinafter. With the third feature, the inner circumferential edge of the first spiral portion 11 includes an inner arc portion, which is shaped approximately as an arc with a radius Ri and a central angle of 90° when viewed in the first direction (Z1-Z2 direction). The outer circumferential edge of the first spiral portion 11 includes an outer arc portion, which is shaped approximately as an arc with a radius Ro and a central angle of 90°, and a connecting portion, which is shaped approximately as an arc or a straight line having a radius larger than the radius Ro. There are four sets of inner and outer arc portions and four connecting portions. The ratio RoA/RiA of the average RoA of the radius Ro of the outer arc portion to the average RiA of the radius Ri of the inner arc portion is from 0.80 to 1.30.

As described above, when viewed in the first direction (Z1-Z2 direction), the inner circumferential edge of the first spiral portion 11 is shaped approximately to include an arc of a semicircle Ci1 having a radius Ri and centered at the point Pi1, an arc of a semicircle Ci2 having a radius Ri and centered at the point Pi2, and two line segments linking the ends of adjacent semicircle arcs. Therefore, the inner circumferential edge of the first spiral portion 11 includes a first inner arc portion Bj1, which is a portion surrounded by the virtual line Lily and the virtual line Lx on the X1 side and the Y1 side and approximates an arc with a central angle of 90°; a second inner arc portion Bj2, which is a portion surrounded by the virtual line Lx and the virtual line Lily on the X1 side and the Y2 side and approximates an arc with a central angle of 90°; a third inner arc portion Bj3, which is a portion surrounded by the virtual line Lily and the virtual line Lx on the X2 side and the Y2 side and approximates an arc with a central angle of 90°; and a fourth inner arc portion Bj4, which is a portion surrounded by the virtual line Lx and the virtual line Lily on the X2 side and the Y1 side and approximates an arc with a central angle of 90°.

When viewed in the first direction (Z1-Z2 direction), the outer circumferential edge of the first spiral portion 11 is shaped approximately to include an arc of a quarter circle Co1 centered at the point Po1, an arc of a quarter circle Co2 centered at the point Po2, an arc of a quarter circle Co3 centered at the point Po3, and an arc of a quarter circle Co4 centered at the point Po4, and four line segments linking the ends of adjacent quarter circle arcs. The radius of each of the four quarter circles Co1-Co4 is Ro.

Therefore, the outer circumferential edge of the first spiral portion 11 includes a first outer arc portion Bp1, which is a portion surrounded by the virtual line Lo1y and the virtual line Lo1x on the X1 side and the Y1 side and approximates an arc with a central angle of 90°; a second outer arc portion Bp2, which is a portion surrounded by the virtual line Lo2x and the virtual line Lo1y on the X1 side and the Y2 side and approximates an arc with a central angle of 90°; a third outer arc portion Bp3, which is a portion surrounded by the virtual line Lo2y and the virtual line Lo2x on the X2 side and the Y2 side and approximates an arc with a central angle of 90°; and a fourth outer arc portion Bp4, which is a portion surrounded by the virtual line Lo1x and the virtual line Lo2y on the X2 side and the Y1 side and approximates an arc with a central angle of 90°.

In addition, the outer circumferential edge of the first spiral portion 11 has a first linear connecting region Bc1 between the first outer arc portion Bp1 and the second outer arc portion Bp2, a second linear connecting region Bc2 between the second outer arc portion Bp2 and the third outer arc portion Bp3, a third linear connecting region Bc3 between the third outer arc portion Bp3 and the fourth outer arc portion Bp4, and a fourth linear connecting region Bc4 between the fourth outer arc portion Bp4 and the first outer arc portion Bp1.

In this way, the first spiral portion 11 has four sets of inner and outer arc portions (first inner arc portion Bj1 and first outer arc portion Bp1, second inner arc portion Bj21 and second outer arc portion Bp2, third inner arc portion Bj3 and third outer arc portion Bp3, and fourth inner arc portion Bj4 and fourth outer arc portion Bp4). The first spiral portion 11 further has four connecting regions (first linear connecting region Bc1 to fourth linear connection region Bc4).

Furthermore, in the first spiral portion 11 included in the coil conductor portion 20 of the coil component 100 in this embodiment, the ratio RoA/RiA is preferably 0.30 or more and 2.50 or less, where RoA is the average of the radii Ro of the four outer arc portions (first outer arc portion Bp1 to fourth outer arc portion Bp4), and RiA is the average of the radii Ri of the four inner arc portions (first inner arc portion Bj1 to fourth inner arc portion Bj4). When the ratio Roa/Ria is 0.30 or more, the DCR can be further reduced while maintaining the inductance as much as possible. Furthermore, when the ratio Roa/Ria is 2.50 or less, it becomes easier to create widening portions in the first spiral portion 11. Therefore, when the ratio Roa/Ria is 0.30 or more and 2.50 or less, a better overall characteristic (L×Isat/DCR) of the coil component 100 can be obtained stably. In consideration of improvement of the overall characteristic (L×Isat/DCR) of the coil component 100, it is preferable that the ratio Roa/Ria is ranged between 0.60 and 1.60, and it is particularly preferable that a range between 0.80 and 1.30 is applied.

In consideration of reliable fulfillment of the overall characteristic (L×Isat/DCR) of a satisfactory coil component 100, it is preferable that the ratio Ro/Ri of the radius Ro to the radius Ri for each of the four sets of inner and outer arc portions of the first spiral portion 11 is 0.30 or more and 2.50 or less, more preferably 0.60 to 1.60, and particularly preferably 0.80 to 1.30.

### (Fourth Feature)

A length of the above-mentioned inner arc portion (arc length) is obtained based on the radius and the central angle of the inner arc portion. Specifically, the arc length Di1 of the first inner arc portion Bj1 is calculated by π×radius Ri×central angle θi1 (unit: °)/360°, the arc length Di2 of the second inner arc portion Bj2 is calculated by 2π×radius Ri×central angle θ12 (unit: °)/360°, the arc length Di3 of the third inner arc portion Bj3 is calculated by 2π×radius Ri×central angle θ13 (unit: °)/360°, and the arc length Di4 of the fourth inner arc portion Bj4 is calculated by 2π×radius Ri×central angle θi4 (unit: °)/360°.

Likewise, the arc length Do1 of the first outer arc portion Bp1 is calculated by 2π×radius Ro×central angle θol (unit: °)/360°, the arc length Do2 of the second outer arc portion Bp2 is calculated by 2π×radius Ro×central angle θo2 (unit: °)/360°, the arc length Do3 of the third outer arc portion Bp3 is calculated by 2π×radius Ro×central angle θo3 (unit: °)/360°, and the arc length Do4 of the fourth outer arc portion Bp4 is calculated by 2π×radius Ro×central angle θo4 (unit: °)/360°.

The first spiral portion 11 included in the coil conductor portion 20 of the coil component 100 in this embodiment has a fourth feature that the ratio DoA/DiA is preferably 0.30 or more and 2.50 or less, where DiA is the average of the arc lengths Di1 to Di4 of the four inner arc portions (first inner arc portion Bj1 to fourth inner arc portion Bj4), and DoA is the average of the arc lengths Do1 to Do4 of the four outer arc portions (first outer arc portion Bp1 to fourth outer arc portion Bp4). When the ratio DoA/DiA is 0.30 or more, the DCR can be further reduced while maintaining the inductance as much as possible. Furthermore, when the ratio DoA/DiA is 2.50 or less, it becomes easier to create widening portions in the first spiral portion 11. Therefore, when the ratio DoA/DiA is 0.30 or more and 2.50 or less, a better overall characteristic (L×Isat/DCR) of the coil component 100 can be stably obtained. From the viewpoint of further improving the overall characteristics (L×Isat/DCR) of the coil component 100, it is more preferable that the ratio DoA/DiA is 0.60 to 1.60, and particularly preferable that it is 0.80 to 1.30.

In consideration of reliable fulfillment of the overall characteristic (L×Isat/DCR) of a satisfactory coil component 100, the ratio Do1/Di1~Do4/Di4 of the arc length Do1~Do4 to the arc length Di1~Di4 for each of the four sets of inner and outer arc portions of the first spiral portion 11 is preferably 0.30 or more and 2.50 or less, more preferably 0.60 to 1.60, and particularly preferably 0.80 to 1.30.

### (Fifth Feature)

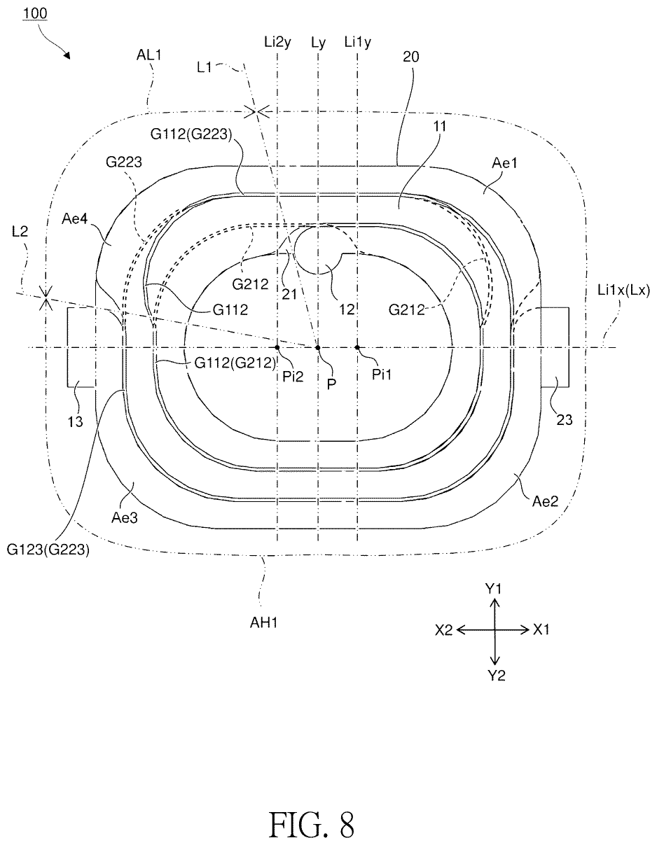

FIG. 8 is an XY plan view illustrating specific structural features (fifth feature and tenth feature) of a first spiral portion and a second spiral portion included in a coil component according to an embodiment of the present invention. In FIG. 8, the gaps disposed in the second spiral portion 21 and invisible due to overlapping with the conductor of the first spiral portion 11 are shown by dashed lines. The coil component 100 in this embodiment has a fifth feature that the first spiral portion 11 has a plurality of turns when viewed in the first direction (Z1-Z2 direction), and includes a first region having a relatively large number of turns and a second region having a relatively small number of turns. Each of the first region and the second region includes the above-described widening portions.

As shown in FIG. 8, the first spiral portion 11 has a first high winding portion AH1 (first region) with three turns, and a first low winding portion AL1 (second region) with fewer turns than the first high winding portion AH1, e.g., two turns. In FIG. 8, a virtual line L1 extending from the point P, which is the position of the axis O of the first spiral portion 11 in the XY plane, to the end part 12, and a virtual line L2 extending from the point P to the end part 13 are shown as the boundary between the first high winding portion AH1 and the first low winding portion AL1. Herein, when viewed from the point P, the virtual line L1 is in contact with the end part 12 on a surface opposite to a spiral conductor portion extending from the end part 12 along the circumferential direction. Likewise, when viewed from point P, the virtual line L2 is in contact with the end part 13 on a surface opposite to a spiral conductor portion extending from the end part 13 along the circumferential direction.

As shown in FIG. 8, the first high winding portion AH1 (first region) has widening portions (first widening portion Ae1, second widening portion Ae2, third widening portion Ae3, and partial fourth widening portion Ae4), and the first low winding portion AL1 (second region) also has a widening portion (partial fourth widening portion Ae4).

### (Sixth Feature)

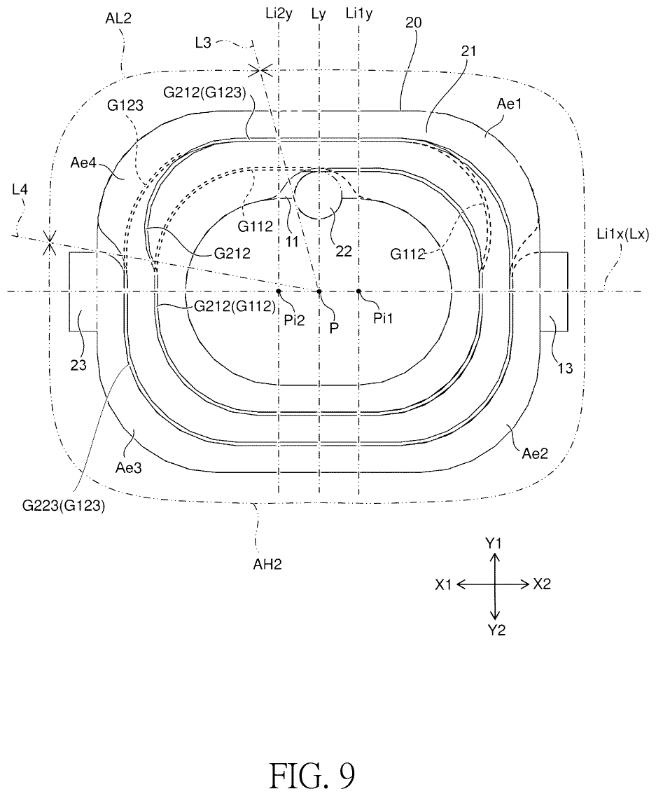

FIG. 9 is an XY plan view illustrating specific structural features (sixth feature and tenth feature) of a first spiral portion and a second spiral portion included in a coil component according to an embodiment of the present invention. In FIG. 9, the gaps disposed in the first spiral portion 11 and invisible due to overlapping with the conductor of the second spiral portion 21 are shown by dashed lines. The coil component 100 in this embodiment has a sixth feature that in addition to the fifth feature described above, the second spiral portion 21 has a plurality of turns when viewed in the first direction, and includes a third region having a relatively large number of turns and a fourth region having a relatively small number of turns. Each of the third region and the fourth region has widening portions.

As shown in FIG. 9, the second spiral portion 21 includes a second high winding portion AH2 (third region) having three turns, and a second low winding portion AL2 (fourth region) having fewer turns than the second high winding portion AH2, e.g., two turns. In FIG. 9, a virtual line L3 extending from the point P, which is the position of the axis O of the second spiral portion 21 in the XY plane, to the end part 22, and a virtual line L4 extending from the point P to the end part 23 are shown as the boundary between the second high winding portion AH2 and the second low winding portion AL2. Herein, when viewed from the point P, the virtual line L3 is in contact with the end part 22 on a surface opposite to a spiral conductor portion extending from the end part 22 along the circumferential direction. Likewise, when viewed from point P, the virtual line L4 is in contact with the end part 23 on a surface opposite to a spiral conductor portion extending from the end part 23 along the circumferential direction.

Furthermore, the second spiral portion 21 is in a mirror image relation to the first spiral portion 11 with the YZ plane as the boundary, as shown in FIG. 9. The configuration of the second spiral portion 21 seen from the Z2 side in the Z1-Z2 direction is identical to the configuration of the first spiral portion 11 seen from the Z1 side in the Z1-Z2 direction. Therefore, like the first spiral portion 11, the second spiral portion 21 has four widening portions (first widening portion Ae1 to fourth widening portion Ae4).

As shown in FIG. 9, the second high winding portion AH2 (third region) has widening portions (first widening portion Ae1, second widening portion Ae2, third widening portion Ae3, and partial fourth widening portion Ae4), and the second low winding portion AL2 (fourth region) also has a widening portion (partial fourth widened portion Ae4).

### (Seventh Feature to Ninth Feature)

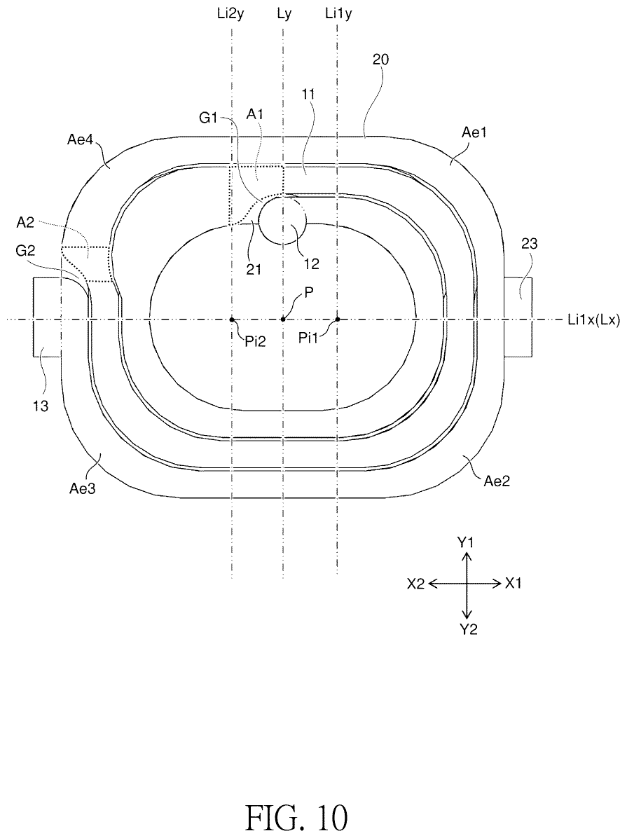

FIG. 10 is an XY plan view illustrating specific structural features (seventh feature to ninth feature) of a first spiral portion included in a coil component according to an embodiment of the present invention. FIG. 10 is a view of the coil conductor portion 20 of the coil component 100 as viewed from the Z1 side in the Z1-Z2 direction, and shows the entire first spiral portion 11 and a part of the second spiral portion 21.

In a region A1, which is enclosed by a thick dotted line as shown in FIG. 10, a turn of the first spiral portion 11 adjacent to the end part 12 through a gap G1, i.e., the second turn from the inside, accommodates at least a part of the end part 12. Furthermore, the width of the conductor located in this region A1 expands in the direction opposite to the spiral direction (the X2 side in X1-X2 direction). The first spiral portion 11 satisfies the seventh feature that the fourth widening portion Ae4 includes the characteristic region A1 as described.

In addition, in the region A1, the turn of the first spiral portion 11 adjacent to the end part 12 through the gap G1, i.e., the second turn from the inside, is located at a position where the turn just passes the end part 12 in the direction opposite to the spiral direction starting from the end part 12 (the X2 side in X1-X2 direction). The first spiral portion 11 satisfies the eighth feature that the fourth widening portion Ae4 has the characteristic region A1.

In a region A2, which is enclosed by a thick dotted line as shown in FIG. 10, a turn of the first spiral portion 11 adjacent to the outmost turn of the first spiral portion 11 through a gap G2, i.e., the second turn from the inside, is located at a position where the turn just passes the outmost turn in the spiral direction starting from the end part 13 (Y1 side in Y1-Y2 direction). Furthermore, the width of the conductor located in the region A2 expands in the spiral direction (Y1 side in Y1-Y2 direction). The first spiral portion 11 satisfies the ninth feature that the fourth widening portion Ae4 has the characteristic region A2.

In the regions A1 and A2, the width of the conductor increases as the two ends 12 and 13 are included in the first spiral portion 11. By partially increasing the width of the conductor of the first spiral portion 11, the resistance value of the first spiral portion 11 is decreased to a relatively low value. Therefore, by imparting at least one of the seventh feature to the ninth feature to the first spiral portion 11, the DCR of the coil component 100 is expected to be reduced and the overall characteristic (L×Isat/DCR) is expected to be improved.

### (Tenth Feature)

In one specific example, the coil component 100 according to the present embodiment may have an insulating film serving as a part of the coil insulator portion between the first spiral portion 11 and the second spiral portion 21 in the first direction (Z1-Z2 direction). In this case, a through hole may be provided in the insulating film, and a via member VP may be provided, passing through the through hole.

In this case, the coil component 100 satisfies the tenth feature that the gaps between the turns of the first spiral portion 11 and the gaps between the turns of the second spiral portion 21 clamp the coil insulator portion formed of the insulating film in between, and have intersecting or merging portions.

As shown in FIGS. 8 and 9, a gap G112 between the first turn and the second turn from the inside of the first spiral portion 11 includes a portion that faces a gap G212 between the first turn and the second turn from the inside of the second spiral portion 21 so as to cooperatively clamp the coil insulator portion made of the insulating film in between. Also, a gap G123 between the second turn and the third turn from the inside of the first spiral portion 11 includes a portion that faces a gap G223 between the second turn and the third turn from the inside of the second spiral portion 21 so as to cooperatively clamp the coil insulator portion made of the insulating film in between. The portions where the gaps face each other are prominent in the first high winding portion AH1 (first region) and the second high winding portion AH2 (third region).

On the other hand, a portion of the second spiral portion 21 facing the first low winding portion AL1 belongs to the second high winding portion AH2 with three turns, and therefore, as shown by the dashed line in FIG. 8, the first low winding portion AL1 (second region) includes a portion where the gap intersects or merges with the coil insulator portion in between. In other words, the gap includes a portion facing the conductor clamping the coil insulator portion. Specifically, as shown in FIG. 8, the gap G112 between the first turn and the second turn from the inside of the first spiral portion 11 has a portion intersecting or merging with the gap G223 (shown by the dashed line in FIG. 8) between the second turn and the third turn from the inside of the second spiral portion 21 in the first low winding portion AL1 (second region). In other words, the gap G112 has a portion facing the conductor of the second turn from the inside of the second spiral portion 21, thereby sandwiching the coil insulator portion made of an insulating film in between. In FIG. 9, the gap G112 facing the conductor of the second spiral portion 21 is shown by a dashed line. In this portion, the width of the conductor located in the first lower winding portion AL1 is widened. Therefore, the DCR of the coil component 100 is expected to be lowered.

Likewise, as shown in FIG. 9, the gap G212 between the first turn and the second turn from the inside of the second spiral portion 21 has a portion intersecting with the gap G123 (shown by a dashed line in FIG. 9) between the second turn and the third turn from the inside of the first spiral portion 11 in the second low winding portion AL2 (fourth region). In other words, the gap G212 has a portion facing the conductor of the second turn from the inside of the first spiral portion 11, thereby sandwiching the coil insulator portion made of an insulating film in between. In FIG. 8, the gap G212 that faces the conductor of the first spiral portion 11 is shown by a dashed line. In this portion, the width of the conductor located in the second low winding portion AL2 is widened. Therefore, the DCR of the coil component 100 is expected to be lowered, and the overall characteristic (L×Isat/DCR) is expected to be improved.

The main body portion 30 is made of a material containing magnetic powder, and includes the first spiral portion 11 and the second spiral portion 21. In this embodiment, the main body portion 30 has a substantially rectangular parallelepiped shape as a specific example. Therefore, in this embodiment, the main body portion 30 has a substantially rectangular shape when viewed in the first direction (Z1-Z2 direction). The main body portion 30 is located on the upper side of the first spiral portion 11 and the second spiral portion 21, the inner side of the inner circumferences thereof, and the outer side of the outer circumferences thereof, and covers all but the ends of the end part 13 and the end part 23 of the coil conductor portion 20.

### (Eleventh Feature)

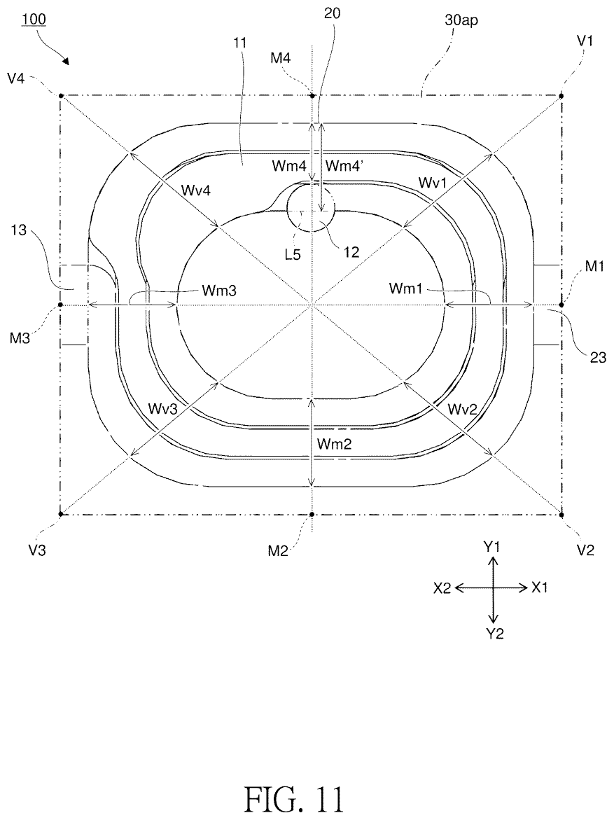

FIG. 11 is an XY plan view illustrating a specific structural feature (eleventh feature) of a first spiral portion included in a coil component according to an embodiment of the present invention. In FIG. 11, the coil conductor portion 20 is drawn with a solid line, and other components are omitted. The first spiral portion 11 satisfies the eleventh feature that the shape of the main body portion 30 is approximately a rectangle, e.g., the rectangle 30ap, when viewed in the first direction (Z1-Z2 direction), and the sum of the lengths of the first spiral portion 11 on two diagonals of the rectangle (approximating rectangle 30ap) is greater than the sum of the lengths of the first spiral portion 11 on two line segments, each connecting the midpoints on two opposing sides of the rectangle (approximate rectangle 30ap).

As shown in FIG. 11, the main body portion 30 shaped approximately as the rectangle 30ap has vertices V1 to V4 when viewed in the first direction (Z1-Z2 direction). Wv1 and Wv3 indicates lengths of the first spiral portion 11 located on two sections of the line segment V1V3, which is a diagonal line linking the two opposite vertices V1 and V3 through the first spiral portion 11. Likewise, Wv2 and Wv4 are the lengths of the first spiral portion 11 located on two sections of the line segment V2V4, which is a diagonal line connecting the other two vertices V2 and V4 through the first spiral portion 11.

On the other hand, in the approximate rectangle 30ap, a midpoint M1 of the line segment V1V2 and a midpoint M3 of the line segment V3V4, which are opposite to each other with the first spiral portion 11 clamped in between. Wm1 and Wm3 are the lengths of the first spiral portion 11 located on the line segment M1M3 linking the midpoints M1 and M3. Similarly, in the approximate rectangle 30ap, a midpoint M2 of the line segment V2V3 and a midpoint M4 of the line segment V4V1 are opposite to each other with the first spiral portion 11 clamped in between. Wm2 and Wm4 are the lengths of the first spiral portion 11 located on the line segment M2M4 linking the midpoints M2 and M4.

The first spiral portion 11 satisfies the eleventh feature that the sum of the lengths of the sections on the diagonals, which traverse the first spiral portion 11, of the approximate rectangle 30ap, i.e. the sum of the lengths Wv1 to Wv4, is greater than the sum of the lengths of the sections of the midpoint-to-midpoint linking lines, which traverse the first spiral portion 11, of the approximate rectangle 30ap, i.e., the sum of the lengths Wm1 to Wm4. In other words, the sum ΣWv of the lengths Wv1 to Wv4 and the sum ΣWm of the lengths Wm1 to Wm4 satisfy ΣWv/ΣWm>1.

In this way, in the portion having a large length across the first spiral portion 11, the width of the conductor of the first spiral portion 11 is widened, and the resistance is reduced to a relatively low value. Therefore, the DCR of the coil component 100 is expected to be lowered, and the overall characteristic (L×Isat/DCR) is expected to be improved. Also, in such a situation that the sum of the lengths Wv1 to Wv4 is relatively large, the conductor of the first spiral portion 11 is present in an area relatively close to vertices of the approximate rectangle 30ap. Thus the magnetic powder of the main body portion 30 located near the vertices of the approximate rectangle 30ap can be effectively utilized. Therefore, from this viewpoint as well, an improvement in the overall characteristic (L×Isat/DCR) of the coil component 100 can be expected.

In consideration of reliable fulfillment of the reduced DCR and the improved overall characteristic (L×Isat/DCR) of the coil component 100, a ratio ΣWv/ΣWm is preferably ranged to be greater than 1.0 and less than 2.0, more preferably in the range of 1.1 to 1.8, and particularly preferably in the range of 1.2 to 1.6, where ΣWv is the sum of the lengths Wv1 to Wv4, and ΣWm is the sum of the lengths Wm1 to Wm4. In consideration of increase of L×Isat of the coil component 100, the ratio ΣWv/ΣWm is preferably 1.3 or more, more preferably 1.4 or more, and particularly preferably 1.7 or more. The above-described correlations are similar for a ratio Wv1/Wm1 of the length Wv1 to the length Wm1 and a ratio Wv4/Wm4 of the length Wv4 to the length Wm4.

In addition, in the situation that the end part 12 is located on the diagonal line or the of the approximate rectangle 30ap, the length Wv1 to the length Wv4 or the length Wm1 to the length Wm4 may be set to exclude the end part 12. In FIG. 11, the end part 12 is located on the midpoint-to-midpoint linking line of the approximate rectangle 30ap. Therefore, Wm4 becomes a length corresponding to the width of two adjacent turns without including the end part 12. In this case, since the influence of the innermost turn is relatively small, as shown by a virtual line L5 in FIG. 11, a virtual inner circumference line is set inside the end part 12, trying to follow the inner circumference around the end part 12. The length Wm4′ of the line segment connecting the intersection of the virtual line L5 and the midpoint-to-midpoint linking line and the intersection of the outer circumference of the first spiral portion 11 and the midpoint-to-midpoint linking line may replace the length Wm4 to derive the CWm.

### (Twelfth Feature)

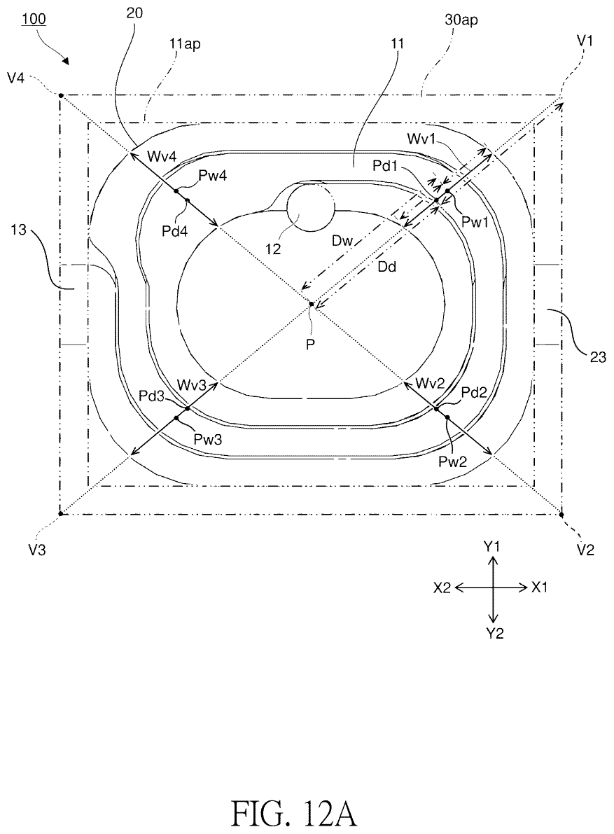

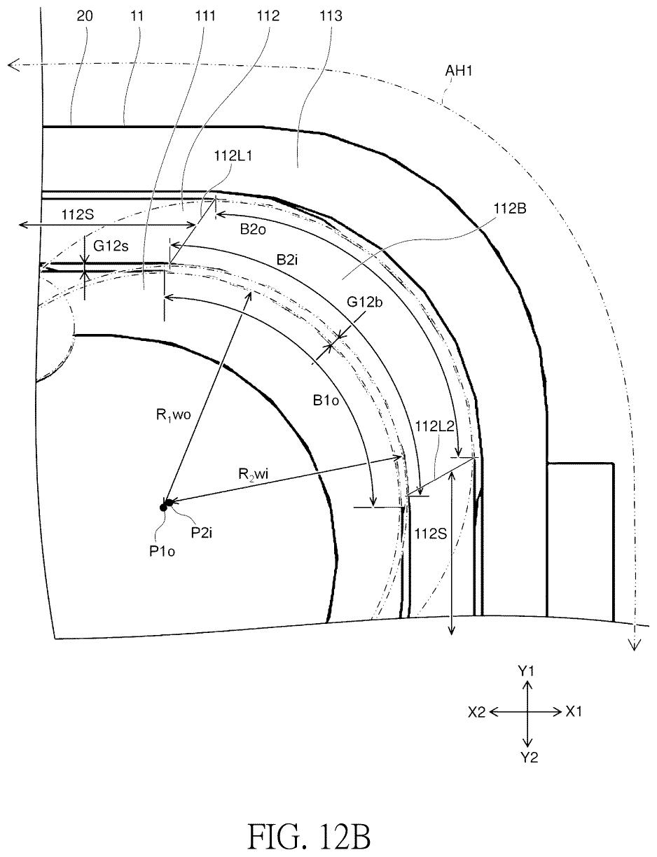

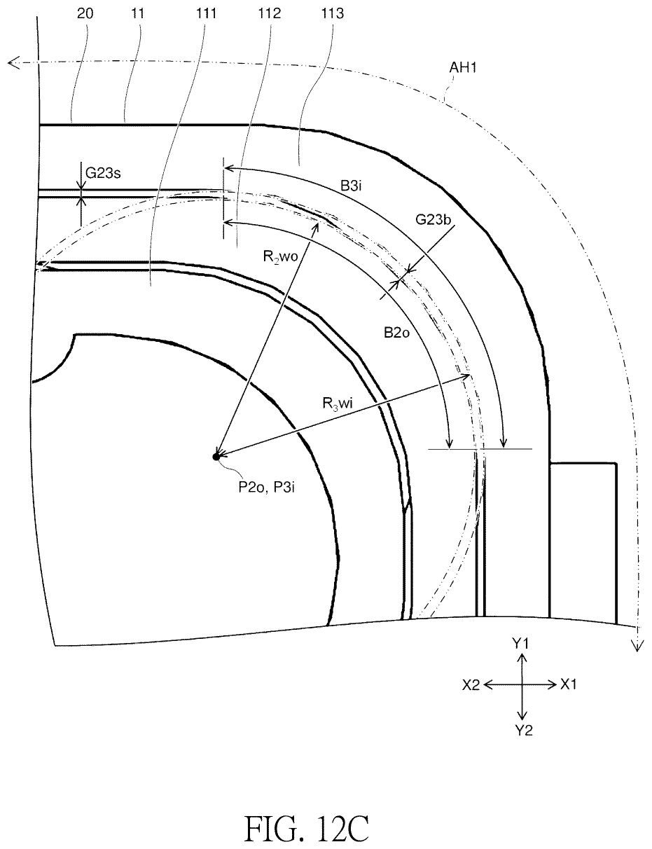

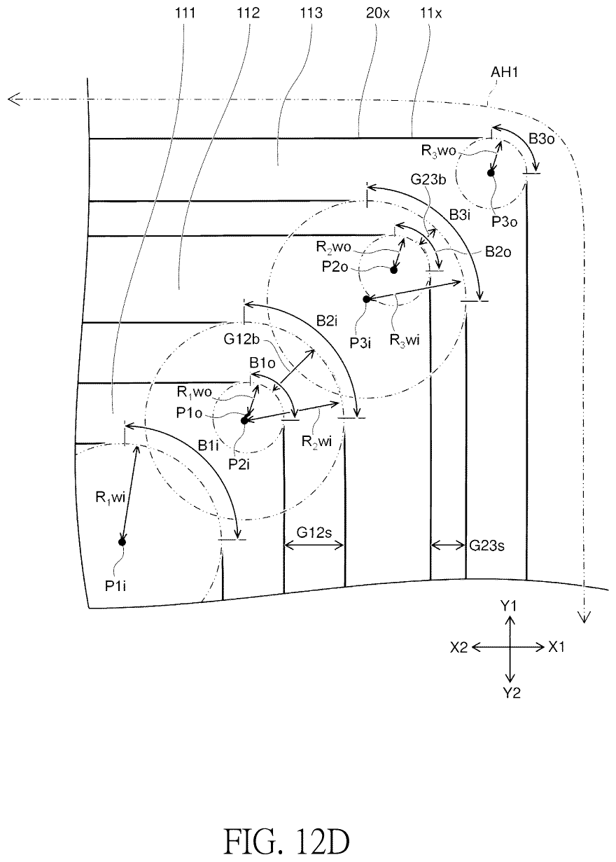

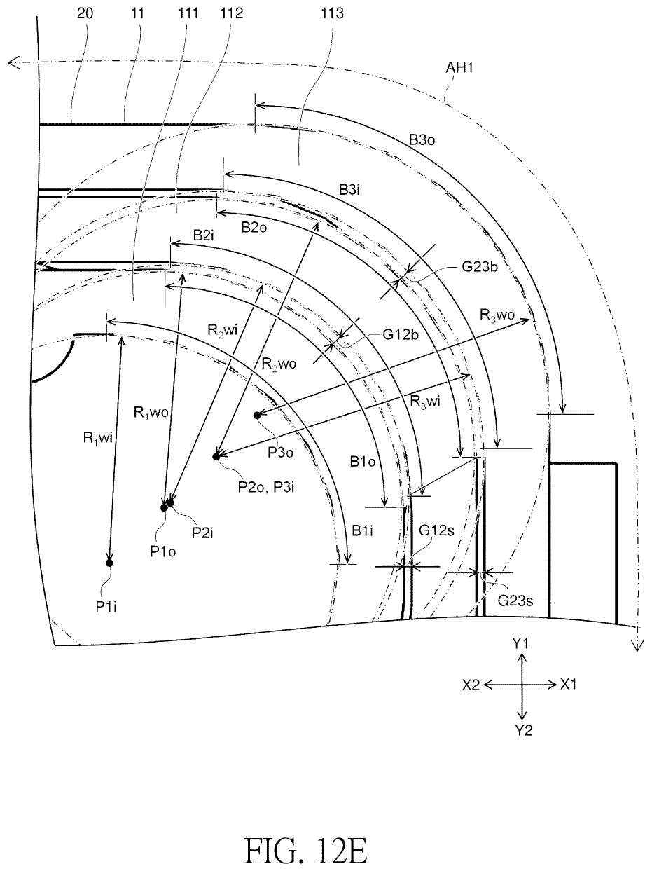

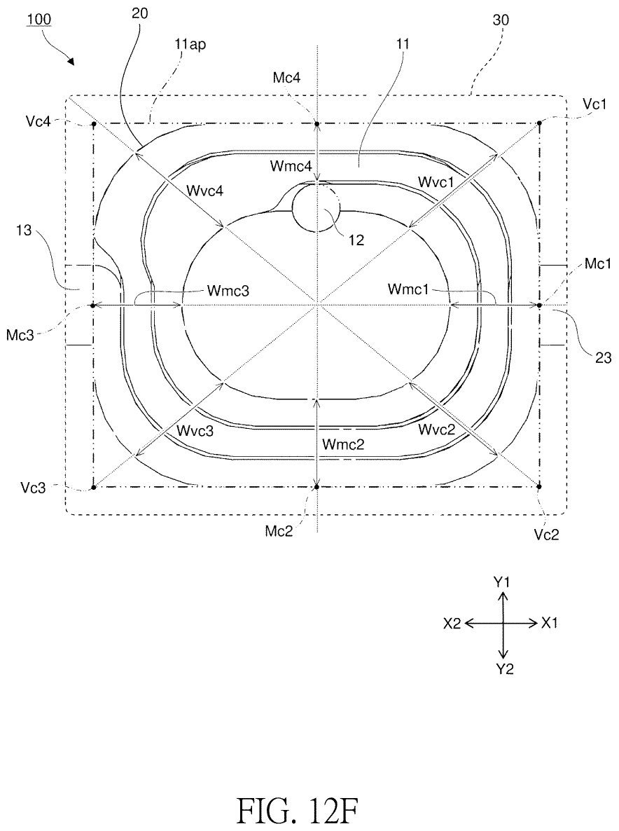

FIG. 12A is an XY plan view illustrating a specific structural feature (twelfth feature) of a first spiral portion included in a coil component according to an embodiment of the present invention. In FIG. 12A, the coil conductor portion 20 is shown with a solid line, and other components are omitted. The first spiral portion 11 satisfies the twelfth feature that the shape of the main body portion 30 is approximately a rectangle, e.g., the rectangle 30ap, when viewed in the first direction (Z1-Z2 direction), and each of the midpoints of the sections on the two diagonals of the rectangle 30ap, which traverse the first spiral portion 11, is located closer to the corresponding vertex than the midpoint of the section between the intersection P of the two diagonals and the corresponding vertex of the rectangle 30ap is. In other words, the first spiral portion 11 satisfies the twelfth feature that a line segment connecting the midpoint of the first spiral portion 11 on the diagonal of the rectangle 30ap to the intersection of the two diagonals has a length equal to or greater than ¼ of the length of the diagonal. In a preferred example, when viewed in the first direction (Z1-Z2 direction), the two diagonals of the approximate rectangle 11ap, by which the outermost edge of the first spiral portion 11 is approximated, are aligned with the two diagonals of the approximate rectangle 30ap representing the outline of the main body portion 30.

In FIG. 12A, when viewed in the first direction (Z1-Z2 direction), a point Pw1 is a midpoint of a section of a line segment V1V3, wherein the line segment V1V3 connects two vertices V1 and V3 of a rectangle approximating the rectangle 30ap, and the section traverses the first spiral portion 11 and has a length Wv1. Likewise, points Pw2, Pw3, and Pw4 are midpoints of similarly defined sections on the diagonal lines, which have respective lengths Wv2, Wv3, and Wv4. In FIG. 12A, a point Pd1 is a midpoint between point P, which is located at the intersection of the two diagonal line segments (line segments V1V3 and V2V4) and the vertex V1. Likewise, points Pd2, Pd3, and Pd4 are midpoints between the point P and the vertices V2, V3, and V4, respectively.

In the first spiral portion 11 having the twelfth feature, the point Pw1 is located closer to the vertex V1 than the point Pd1 is. Similarly, the points Pw2, Pw3, and Pw4 are located closer to the vertices V2, V3, and V4, respectively, than the corresponding points Pd2, Pd3, and Pd4 are. In other words, the distance Dw between the point P and the point Pw1 is greater than the distance Dd between the point P and the point Pd1, i.e., Dw/Dd>1 is satisfied. The correlations also hold true for the points Pw2, Pw3, and Pw4 relative to the vertices V2, V3, and V4, respectively. As long as Dw/Dd>1 holds true for at least one of the points Pd1, Pw2, Pw3, and Pw4, it can be determined that the first spiral portion 11 has the twelfth feature. In a situation that the first spiral portion 11 has the twelfth feature, the conductor of the first spiral portion 11 is present in an area relatively close to vertices of the approximate rectangle 30ap. Thus the magnetic powder of the main body portion 30 located near the vertices of the approximate rectangle 30ap can be effectively utilized. Therefore, an improvement in the overall characteristic (L×Isat/DCR) of the coil component 100 can be expected.

In consideration of reliable fulfillment of the reduced DCR and the improved overall characteristic (L×Isat/DCR) of the coil component 100, the ratio of the distance between the point Pw1 and the point Pd1 to the distance Dd between the point P and the point Pd1 is preferably in the range of 0.01 to 0.20, and more preferably in the range of 0.05 to 0.15. This correlation also applies to the ratio of the distance between the point Pw2 and the point Pd2 to the distance between the point P and the point Pd2, the ratio of the distance between the point Pw3 and the point Pd3 to the distance between the point P and the point Pd3, the ratio of the distance between the point Pw4 and the point Pd4 to the distance between the point P and the point Pd4, and the ratio of the sum of the distance between the point Pw1 and the point Pd1, the distance between the point Pw2 and the point Pd2, the distance between the point Pw3 and the point Pd3, and the distance between the point Pw4 and the point Pd4 to the distance points Pw4 and Pd4 to the sum of the distances between the point P and the points Pd1, Pd2, Pd3, and Pd4, respectively.

### (Thirteenth Feature)

FIG. 12B is a first XY plan view illustrating a specific structural feature (thirteenth feature) of a first spiral portion included in a coil component according to an embodiment of the present invention. FIG. 12C is a second XY plan view illustrating a specific structural feature (thirteenth feature) of a first spiral portion included in a coil component according to an embodiment of the present invention. FIG. 12D is an XY plan view illustrating a specific structural feature of a first spiral portion included in a coil component in a comparative example. In FIGS. 12B to 12D, a part of the coil conductor portion 20 is shown with a solid line, and other components are omitted.

As a thirteenth feature, the first spiral portion 11 has a plurality of turns when viewed in a first direction (Z1-Z2 direction). Similar to the fifth feature described above, the first spiral portion 11 includes a first region (first high winding portion AH1) having a relatively large number of turns and a second region (first low winding portion AL1) having a relatively small number of turns when viewed in the first direction (Z1-Z2 direction). In the first region (first high winding portion AH1), the first spiral portion 11 has n turns (n is a natural number equal to or greater than 2).

Herein, for the multiple turns located in the first region (first high winding portion AH1), the turn located at the innermost part is defined as the first turn, the turn located at the outermost part is defined as the nth turn, and each of the turns located in the first region are defined in a distinguishable way. Specifically, in the example shown in FIGS. 12B and 12C, n=3, and the first spiral portion 11 has three turns in the first region (first high winding portion AH1), i.e., the first turn 111, the second turn 112, and the third turn 113.

In a case that the first spiral portion 11 has the thirteenth feature, when j is a natural number equal to or smaller than n−1, there exists at least one j that satisfies the following conditions (1) to (3):
(1) The outer conferential edge of the jth turn has an outer curved portion of the jth turn, where the radius of curvature decreases and then increases.
(2) The inner conferential edge of the j+1th turn opposite to the outer conferential edge of the jth turn has an inner curved portion of the jth turn, where the radius of curvature decreases and then increases.
(3) The minimum radius of curvature Rjwo of the outer curved portion of the jth turn and the minimum radius of curvature Rj+1wi of the inner curved portion of the j+1th turn satisfy the correlation of Rjwo/Rj+1wi≥0.9.

Specifically, as shown in FIG. 12B, in the first region (first high winding portion AH1), the first turn 111 has an outer curved portion B1o of the first turn, where the radius of curvature decreases and then increases, and the inner circumferential edge of the second turn 112 facing the outer circumferential edge of the first turn 111 has an inner curved portion B2i of the second turn, where the radius of curvature decreases and then increases.

Furthermore, a minimum radius of curvature R1wo of the outer curved portion Blo of the first turn and a minimum radius of curvature R2wi of the inner curved portion B2i of the second turn satisfy R1wo/R2wi20.9. The circle that gives the minimum radius of curvature R1wo is centered at a point P1o, and the circle that gives the minimum radius of curvature R2wi is centered at a point P2i. When R1wo/R2wi satisfies the condition of equal to or less than 0.9, a gap G12b between the outer curved portion Blo of the first turn and the inner curved portion B2i of the second turn and a gap G12s between the linear portion of the first turn 111 connected to the outer curved portion Blo of the first turn and the linear portion of the second turn 112 connected to the inner curved portion B2i of the second turn have substantially equal length, as viewed in the first direction (Z1-Z2 direction).

Herein, the curved portion and the linear portion will be described using the second turn 112 as an example. In FIG. 12A, it is shown that the second turn 112 includes the outer curved portion B20 and the inner curved portion B2i of the second turn. In the second turn 112, a region surrounded by the line segment 112L1 connecting an end point of the inner curved portion B2i and an end point of the outer curved portion B20, the line segment 112L2 connecting another end point of the inner curved portion B2i and another end point of the outer curved portion B20, together with the inner curved portion B2i and the outer curved portion B20 is defined as a “curved region 112B”. In contrast, a region connected to the curved region 112B, in which the inner circumferential edge and the inner circumferential edge of the second turn 112 are linear, is defined as the “linear region 112S”. The same definitions are applied to other turns.

As described above, the gap G12b in the curved region 112B and the gap G12s in the linear region 112S have approximately equal length. Therefore, the length of the gap between the first turn 111 and the second turn 112 can be set to be approximately equal at any position. At this time, when viewed in the first direction (Z1-Z2 direction), a ratio of the total gap length to the width of the first spiral portion 11 becomes smaller. This smaller ratio means that the conductor occupies more area of the first spiral portion 11, and thus results in lower DC resistance DCR of the coil component 100.

FIG. 12C, in the first region (first high winding portion AH1), the second turn 112 has an outer curved portion B20 of the second turn, whose radius of curvature decreases and then increases, and the inner circumferential edge of the third turn 113 facing the outer circumferential edge of the second turn 112 has an inner curved portion B3i of the third turn, whose radius of curvature decreases and then increases. A minimum radius of curvature R2wo of the outer curved portion B20 of the second turn and a minimum radius of curvature R3wi of the inner curved portion B3i of the third turn satisfy the correlation of R2wo/R3wi≥20.9. The circle that gives the minimum radius of curvature R2wo is centered at a point P20, and the circle that gives the minimum radius of curvature R3wi is centered at a point P3i. When the ration R2wo/R3wi satisfies the condition of equal to or less than 0.9, a gap G23b between the outer curved portion B20 of the second turn 112 and the inner curved portion B3i of the third turn 113 and the gap G23s between the linear portion of the second turn 112 connected to the outer curved portion B20 of the second turn 112 and the linear portion of the third turn 113 connected to the inner curved portion B3i of the third turn 113 have substantially equal length, as viewed in the first direction (Z1-Z2 direction). Therefore, the length of the gap between the second turn 112 and the third turn 113 can be set to be substantially equal at any position, which contributes to reducing the DC resistance DCR of the coil component 100 as described above.

In the coil component 100 according to the present embodiment, it is preferable that Rjwo/Rj+1wi≥0.9 is satisfied for all j in terms of reducing the DC resistance DCR of the coil component 100. As shown in the simulation results to be described in detail later, in the coil component 100 according to the present embodiment, respective values of the ratio Rjwo/Rj+1wi for a plurality of turns in the first region (first high winding portion AH1) are obtained, and the average value R1 of these values is preferably 0.9 or more, more preferably 0.95 or more, and even more preferably 1.0 or more. The higher the average value R1, the higher the product (L×Isat) of the self-inductance L and the DC superimposed rated current Isat tends to be. Therefore, when the self-inductance L of the coil component 100 is predetermined in consideration of circuitry, the higher the average value R1, the more the current that can flow through, and it is desirable.

FIGS. 12B and 12C show only a part of the first region (first high winding portion AH1) of the first spiral portion 11 of the coil component 100 according to the present embodiment, wherein the first region (first high winding portion AH1) of the first spiral portion 11 has two additional curved portions, which are similarly configured. Specifically, what is shown in FIG. 12B and FIG. 12C includes a portion containing the first outer curved portion Bo1 illustrated in FIG. 6. In addition, a portion containing the second outer curved portion Bo2 of FIG. 6, and a portion containing the third outer curved portion Bo3 of FIG. 6 also satisfy the above conditions (1) and (2), just like the portion containing the first outer curved portion Bo1 of FIG. 6. It is preferable that these portions also have j that satisfies the condition (3), i.e., Rjwo/Rj+1wi≥0.9, and it is more preferable that all j in these portions satisfy the condition (3). Furthermore, for the portion containing the second outer curved portion Bo2 and the portion containing the third outer curved portion Bo3 shown in FIG. 6, the average value R1 is preferably 0.9 or more, more preferably 0.95 or more, and even more preferably 1.0 or more.

In contrast, in a comparative example, a first spiral portion 11x of a coil conductor portion 20x of a coil component has an outer curved portion Blo of the first turn and an inner curved portion B2i of the second turn, as well as an outer curved portion B20 of the second turn and an inner curved portion B3i of the third turn, as shown in FIG. 12D. However, the conditions of R1wo/R2wi≥0.9 and R2wo/R3wi≥0.9 are not satisfied.

As a result, the outer curved portion of each turn has a structure showing an excessively outward protrusion. Such an excessively outward protrusion (protruding portion) hinders current from flowing through, and the DC resistance DCR in a curved region (such as curved region 112B) tends to increase. In addition, when winding the turns, it is necessary to prevent the protruding portion from contacting the inner circumference of the outer turn.

Accordingly, the width of the turn having the linear region (linear region 112S) connected to the curved region (curved region 112B) is narrowed. Specifically, since there is a sufficient gap between the first turn 111 and the second turn 112, there is not much difference between the gap G12b between the outer curved portion Blo of the first turn and the inner curved portion B2i of the second turn and the gap G12s between the linear region of the first turn 111 connected to the outer curved portion Blo of the first turn and the linear region of the second turn 112 connected to the inner curved portion B2i of the second turn. In contrast, for winding the second turn 112 and the third turn 113 having therein a gap narrower than the gap between the first turn 111 and the second turn 112, the gap G23b between the outer curved portion B20 of the second turn and the inner curved portion B3i of the third turn is narrower than the gap G23s between the linear region of the second turn 112 connected to the outer curved portion B20 of the second turn and the linear region of the third turn 113 connected to the inner curved portion B3i of the third turn. This gap G23b becomes a bottleneck, and there is a limit to the narrowing of the gap between the second turn 112 and the third turn 113. Therefore, it is unlikely for the conductor to occupy more area of the first spiral portion 11x, and thus the DC resistance DCR of the coil component 100 is unlikely to decrease.

### (Fourteenth Feature)

FIG. 12E is an XY plan view illustrating a specific structural feature (fourteenth feature) of a first spiral portion included in a coil component according to an embodiment of the present invention. When viewed in a first direction (Z1-Z2 direction), the first spiral portion 11 has a plurality of turns, and includes a first region (first high winding portion AH1) having a relatively large number of turns and a second region (first low winding portion AL1) having a relatively small number of turns. In the first region (first high winding portion AH1), the first spiral portion 11 has n turns (n is a natural number equal to or greater than 2).

Herein, for the multiple turns located in the first region (first high winding portion AH1), the turn located at the innermost part is defined as the first turn, the turn located at the outermost part is defined as the nth turn, and each of the turns located in the first region are defined in a distinguishable way. Specifically, in the example shown in FIGS. 12B and 12C, n=3, and the first spiral portion 11 has three turns in the first region (first high winding portion AH1), i.e., the first turn 111, the second turn 112, and the third turn 113.

In the case that the first spiral portion 11 has the fourteenth feature, when k is a natural number equal to or less than n, the following conditions (i) to (iii) are satisfied for all k:
(i) The kth-turn outer conferential edge has an outer curved portion of the kth turn, where the radius of curvature decreases and then increases.
(ii) The kth-turn inner conferential edge has a kth-turn inner curved portion, where the radius of curvature decreases and then increases.
(iii) The ratio of the minimum radius of curvature Rkwo of the kth-turn outer curved portion to the minimum radius of curvature Rkwi of the kth-turn inner curved portion satisfies the condition that Rkwo/Rkwi is from 0.8 to 1.2.

Specifically, as shown in FIG. 12E, in the first region (first high winding portion AH1), the first turn 111 has the outer curved portion Blo of the first turn, whose radius of curvature decreases and then increases, and the inner curved portion Bli of the first turn, whose radius of curvature decreases and then increases. The second turn 112 has the outer curved portion B20 of the second turn, whose radius of curvature decreases and then increases, and the inner curved portion B2i of the second turn, whose radius of curvature decreases and then increases. The third turn 113 has the outer curved portion B30 of the third turn, whose radius of curvature decreases and then increases, and the inner curved portion B3i of the third turn, whose radius of curvature decreases and then increases.

Furthermore, the ratio R1wo/R1wi of the minimum radius of curvature R1wo of the outer curved portion Blo of the first turn to the minimum radius of curvature R1wi of the inner curved portion Bli of the first turn is from 0.8 to 1.2. Meanwhile, the ratio R2wo/R2wi of the minimum radius of curvature R2wo of the outer curved portion B20 of the second turn to the minimum radius of curvature R2wi of the inner curved portion B2i of the second turn is from 0.8 to 1.2. The ratio R3wo/R3wi of the minimum radius of curvature R3wo of the outer curved portion B30 of the third turn to the minimum radius of curvature R3wi of the inner curved portion B3i of the third turn is from 0.8 to 1.2. The center of the circle that gives the minimum radius of curvature R1wi is the point P1i, and the center of the circle that gives the minimum radius of curvature R1wo is the point P1o. The center of the circle that gives the minimum radius of curvature R2wi is the point P2i, and the center of the circle that gives the minimum radius of curvature R2wo is the point P20. The center of the circle that gives the minimum radius of curvature R3wi is the point P3i, and the center of the circle that gives the minimum radius of curvature R3wo is the point P30.

In this case, since the width of the curved region does not change significantly compared to the width of the linear region, the DC resistance DCR might not increase with decrease of the width occurring locally in the curved region. Furthermore, the DC resistance DCR might not increase with the increase of the gap in the linear region due to the excessively protruding outer part of the curved region. What is shown in FIG. 12E includes a portion containing the first outer curved portion Bo1 illustrated in FIG. 6. In addition, a portion containing the second outer curved portion Bo2 of FIG. 6, and a portion containing the third outer curved portion Bo3 of FIG. 6 also satisfy the above conditions (i) and (ii), just like the portion containing the first outer curved portion Bo1 of FIG. 6. It is preferable that these portions also satisfy the condition (iii).

In the comparative example shown in FIG. 12D, R1wo/R1wi, R2wo/R2wi, and R3wo/R3wi are all less than 0.5, and there is concern about an increase in DC resistance DCR due to excessive protrusion of the outer part of the curved region.

### (Fifteenth Feature)

FIG. 12F is an XY plan view illustrating a specific structural feature (fifteenth feature) of a first spiral portion included in a coil component according to an embodiment of the present invention. In FIG. 12F, the coil conductor portion 20 is shown with a solid line, and other components are omitted. The first spiral portion 11 has the following fifteenth feature. First, when viewed in the first direction (Z1-Z2 direction), the first spiral portion 11 is approximately shaped as a rectangle (approximate rectangle 11ap). At this time, it satisfied the condition that at least one of the lengths of the first spiral portion 11 located on two diagonals of the rectangle (approximate rectangle 11ap) is greater than at least one of the lengths of the first spiral portion 11 located on two line segments, each connecting the midpoints of two opposite sides of the rectangle (approximate rectangle 11ap). In a preferred example, when viewed in the first direction (Z1-Z2 direction), the two diagonals of the approximate rectangle 11ap at the outermost edge of the first spiral portion 11 extend along the two diagonals of the approximate rectangle 30ap of the main body portion 30.

As shown in FIG. 12F, the approximate rectangle 11ap of the first spiral portion 11 has vertices Vc1, Vc2, Vc3, and Vc4, when viewed in the first direction (Z1-Z2 direction). The sections of the first spiral portion 11 located on the line segment Vc1Vc3, which is a diagonal line connecting the two vertices Vc1 and Vc3 facing each other across the first spiral portion 11, have respective lengths Wvc1 and Wvc3. Similarly, the sections of the first spiral portion 11 located on the line segment Vc2Vc4, which is a diagonal line connecting the other two vertices Vc2 and Vc4 facing each other across the first spiral portion 11, have respective lengths Wvc2 and Wvc4.

On the other hand, in the approximate rectangle 11ap, a midpoint Mc1 of the side Vc1Vc2 and a midpoint Mc3 of the side Vc3Vc4 face each other with the first spiral portion 11 in between. The sections of the first spiral portion 11 located on the line segment Mc1Mc3 connecting the midpoints Mc1 and Mc3 have respective lengths Wmc1 and Wmc3. Similarly, in the approximate rectangle 11ap, a midpoint Mc2 of the side Vc2Vc3 and a midpoint Mc4 of the side Vc4Vc1 face each other with the first spiral portion 11 in between. The sections of the first spiral portion 11 located on the line segment Mc2Mc4 connecting the midpoints Mc2 and Mc4 have respective lengths Wmc2 and Wmc4.

The fifteenth feature of the first spiral portion 11 is that the maximum value of the length Wvc1 to the length Wvc4 is greater than the minimum value of the length Wmc1 to the length Wmc4. With this feature, the shape of the first spiral portion 11 becomes closer to the approximate rectangle 11ap, and the magnetic powder of the main body portion 30 located near the vertices of the approximate rectangle 30ap can be effectively utilized. Therefore, an improvement in the overall characteristic (L×Isat/DCR) of the coil component 100 is expected. In a preferred example, the maximum value of the length Wvc1 to the length Wvc4 is greater than the maximum value of the length Wmc1 to the length Wmc4. In a more preferred example, the minimum value of the length Wvc1 to the length Wvc4 is greater than the maximum value of the length Wmc1 to the length Wm4.

The structure of the magnetic powder contained in the main body portion 30 is not limited. This structure may include a crystalline phase or an amorphous phase. Herein, a crystalline material is defined as a material formed of a crystalline phase, an amorphous material is defined as a material formed of an amorphous phase, and a composite material is defined as a material including a crystalline material and an amorphous material. In a situation that the diffraction spectrum obtained by a general X-ray diffraction method includes a sharp diffraction peak that can identify the type of crystalline phase, the material includes a crystalline phase. On the other hand, in the situation that the diffraction spectrum obtained by a general X-ray diffraction method includes a broad peak indicating an amorphous phase, the material includes an amorphous phase. If the DSC curve obtained by differential thermal analysis includes a peak indicating crystallization, i.e., heat generation associated with a phase change from an amorphous phase to a crystalline phase, the material includes an amorphous phase.

The material system of the magnetic powder is not limited.

Specific examples of the crystalline material include Fe—Si—Cr based alloys, Fe—Ni based alloys, Fe—Co based alloys, Fe—V based alloys, Fe—Al based alloys, Fe—Si based alloys, Fe—Si—Al based alloys, iron only, and ferrite. It is preferable to use carbonyl iron powder as iron-only powder. Specific examples of the amorphous material include Fe—Si—B based alloys, Fe—P—C based alloys, and Co—Fe—Si—B based alloys. Specific examples of composite materials include Fe—Zr based alloys, Fe—Zr—B based alloys, Fe—Si—B—Nb—Cu based alloys, and Fe—Si—B—P—Cu based alloys. If the magnetic powder is metal powder containing Fe, the synergistic effect on improvement of magnetic properties is particularly significant.

The chemical composition of the magnetic powder is not limited. For example, the Fe—Si—Cr based alloy may be composed of 1.0-10.0 mass % Si, 1.0-10.0 mass % Cr, and the remainder composed of Fe and impurities. Also, for example, the Fe—Ni based alloy may be composed of 1.0-99.0 mass % Ni, and the remainder composed of Fe and impurities. Furthermore, for example, the Fe—P—C based alloy may be composed of 1.0-13.0 atom % P, 1.0-13.0 atom % C, Fe, and impurities. The Fe—P—C based alloy may contain one or more optional elements selected from the group consisting of Ni, Sn, Cr, B, and Si. In this case, for example, the amount of Ni may be 0 to 10.0 atomic %, the amount of Sn may be 0 to 3.0 atom %, the amount of Cr may be 0 to 6.0 atom %, the amount of B may be 0 to 9.0 atom %, and the amount of Si may be 0 to 7.0 atom %. The amount of Fe is preferably 65 atom % or more. Also, for example, the Fe—Si—B—Nb—Cu based alloy may be composed of 1.0 to 16.0 atom % Si, 1.0 to 10.0 atom % B, 0.50 to 5.0 atom % Nb, 0.50 to 5.0 atom % Cu, and the balance consisting of Fe and impurities. In this case, the amount of Fe is preferably 65 atom % or more.

The shape of the magnetic powder contained in the main body portion 30 is not limited. The magnetic powder may be spherical, elliptical, scaly, or of an irregular shape. The manufacturing method for rendering these shapes is also not limited.

The particle size distribution of the magnetic powder is not limited. The particle size distribution of the magnetic powder can be obtained, for example, by analyzing an image (secondary electron image), which is an image of a cut surface of the main body portion 30 obtained with a scanning electron microscope. For example, the average equivalent circular diameter (ECD) of the magnetic powder may be 0.50 to 50.0 μm. The distribution of the equivalent circular diameter may include multiple peaks.

The magnetic powder may be subjected to a surface insulating treatment. Provided that the magnetic powder is subjected to a surface insulating treatment, the insulation resistance of the main body portion 30 is improved. There is no limitation on the type of surface insulating treatment applied to the magnetic powder.

Examples include phosphoric acid treatment, phosphate treatment, and oxidation treatment. The magnetic powder may have an insulating coating on the surface of the magnetic particles. This insulating coating may contain at least one selected from a group consisting of Si, P, and B, and O (oxygen).

The magnetic powder may be a mixed material in which multiple powder materials are mixed. This magnetic powder is preferably a ferromagnetic material, and more preferably a soft magnetic material.

The main body portion 30 may further include an optional auxiliary material. The optional auxiliary material is, for example, a binder material or a modifier. The binder material bonds particles such as magnetic powder contained in the main body portion 30 together. This binder material is preferably an insulating material to impart insulation resistance to the main body portion 30.

The binding component may be an organic material or an inorganic material. The organic material may be a resin material. Examples of the resin material include acrylic resin, silicone resin, epoxy resin, phenol resin, urea resin, melamine resin, and polyester resin. The inorganic material may be a glass-based material such as water glass. The binding material may be a product of a reaction such as thermal decomposition, or may be a mixture of multiple materials.

The modifier, for example, improves the mobility of the powder or adjusts the curing speed of the binder material. The modifier may be a glass-based material.

As shown in FIGS. 1 and 2, the two ends 13 and 23 of the coil conductor portion 20 are exposed on the side surfaces of the main body portion 30 aligned in the X1-X2 direction (second direction). A first terminal member 41 is provided to be in electrical contact with one of the two exposed ends 13 and 23, and a second terminal member 42 is provided to be in electrical contact with the other of the two ends 13 and 23.

The first terminal member 41 has a side portion 41a that covers the side surface of the main body portion 30 on the X2 side in the X1-X2 direction, and a bottom portion 41b that is provided to cover partially the bottom surface (the surface on the Z2 side in the Z1-Z2 direction) of the main body portion 30. The bottom portion 41b is the part that faces the board when in use. The second terminal member 42 has a side portion 42a that covers the side surface of the main body portion 30 on the X1 side in the X1-X2 direction, and a bottom portion 42b that is provided on the bottom surface of the main body portion 30 to cover partially the bottom surface while being spaced apart from the bottom portion 41b. The bottom portion 42b is also the part that faces the board when in use.

The positions of the first terminal member 41 and the second terminal member 42 are not limited to the positions described above. The first terminal member 41 and the second terminal member 42 may also be formed to cover partially the upper surface of the main body portion 30. The first terminal member 41 and the second terminal member 42 may also be provided on only partially the bottom surface of the main body portion 30. In this case, the coil member 10 may include a connecting conductor (not shown) that connects the two ends 13 and 23 of the coil member 10 to the bottom surface of the main body portion 30 through the inside of the main body portion 30. The end part 13 of the first spiral portion 11 and the end part 23 of the second spiral portion 21 may not be exposed from the side surface of the main body portion 30, while the connecting conductor may be exposed from the bottom surface of the main body portion 30.

The material and configuration of the first terminal member 41 and the second terminal member 42 are not limited as long as they have appropriate conductivity. One non-limiting example of the first terminal member 41 and the second terminal member 42 is a layer having a structure of Cu plating/Ni plating/Sn plating from the side proximal to the surface of the main body portion 30. The first terminal member 41 and the second terminal member 42 may be composed of a coated electrode, in which a conductive material such as silver is dispersed in a resin or the like. The first terminal member 41 and the second terminal member 42 may also be a combination of plated layer and coated electrode.

The upper surface of the main body portion 30 (the surface on the Z1 side in the Z1-Z2 direction) and the side surfaces in the Y1-Y2 direction (third direction) are each provided with an insulating outer cover 50, 60. An insulating outer cover may also be provided on a portion of the bottom surface of the main body portion 30, where the bottom surface portions 41b and 42b are not provided. Furthermore, the coil component 100 may not be provided with the outer covers 50 and 60. The outer covers 50 and 60 can be formed at any position on the surface of the main body portion 30 depending on practical requirements.

The manufacturing method of the coil component according to this embodiment is not particularly limited. One non-limiting example of the manufacturing method is as follows.

First, an insulating negative pattern corresponding to the first spiral portion 11 is formed on one side of an insulating substrate such as glass epoxy or polyimide, and an insulating negative pattern corresponding to the second spiral portion 21 is formed on the other side of the substrate. The base material has a through hole in a portion corresponding to the via member VP.

By copper plating both sides of the negative patterned substrate thus obtained and then removing the negative pattern, a structure, in which the substrate has the first spiral portion 11 made of copper plating on one side and the second spiral portion 21 made of copper plating on the other side, is obtained. The copper plating fills the through hole of the substrate, and serving as a part of the via member VP.

This structure is disposed in a mold cavity that has a cavity corresponding to the main body portion 30. The magnetic powder prepared as described above is filled into the mold cavity, and a molding process including pressurization, heating, etc., is performed to obtain the main body portion 30 including the first spiral portion 11 and the second spiral portion 21.

The first terminal member 41 is provided to be electrically connected to the end part 13 exposed from the side surface of the main body portion 30, and the second terminal member 42 is provided to be electrically connected to the end part 23 that is also exposed. Finally, the outer covers 50 and 60 are provided to cover the exposed portion of the main body portion 30, thereby obtaining the coil component 100.

### (Electronic/Electric Device)

The electronic/electrical device according to one embodiment of the present invention is an electronic/electric device in which the coil component 100 according to one embodiment of the present invention is installed. The coil component 100 is connected to a substrate at the first terminal member 41 and the second terminal member 42. The electronic/electric device according to one embodiment of the present invention is easily miniaturized because it is mounted with the coil component 100 according to one embodiment of the present invention. Furthermore, even if a large current passes through the device or a high frequency is applied, malfunctions caused by deterioration of the function of the coil component 100 or heat generation are unlikely to occur.

### Embodiments

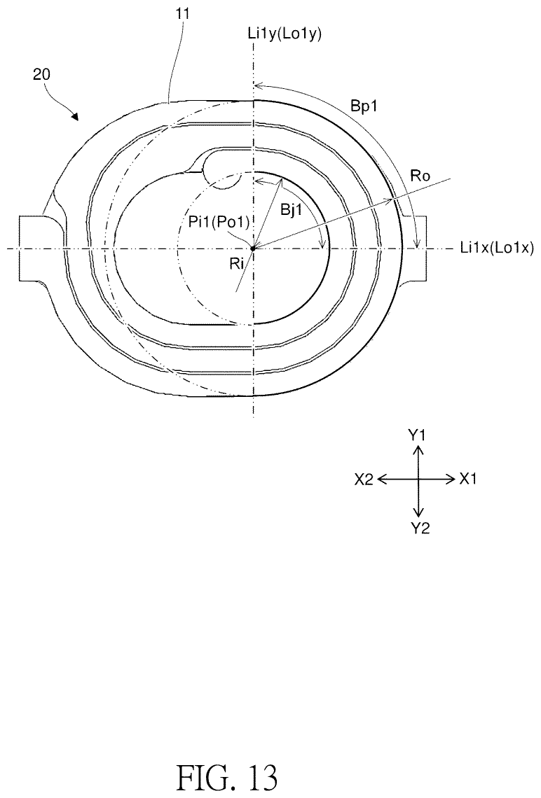

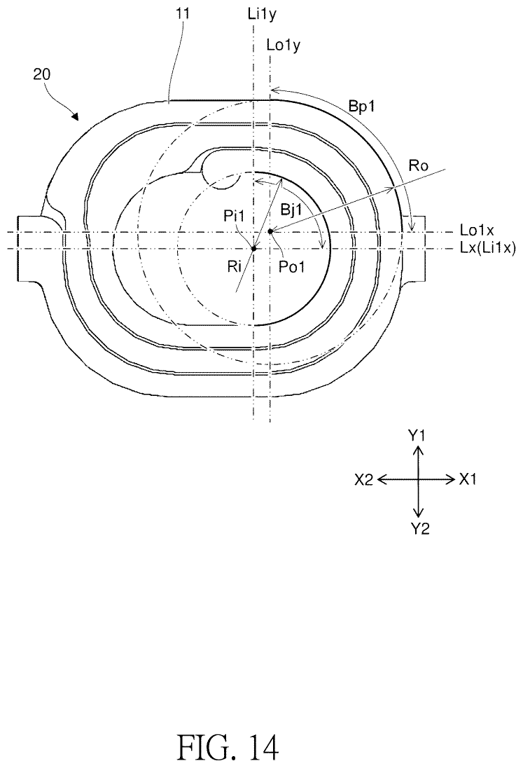

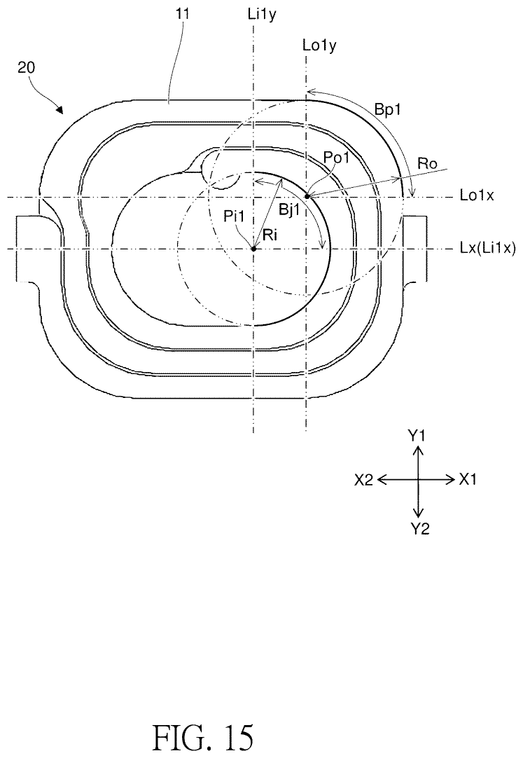

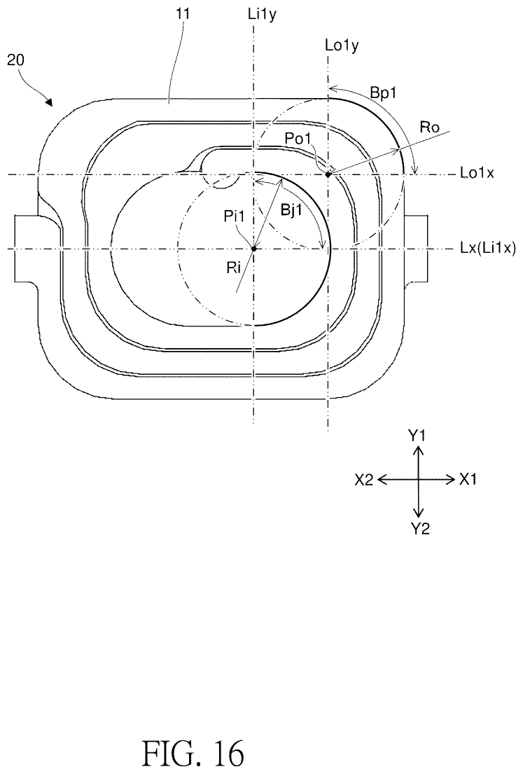

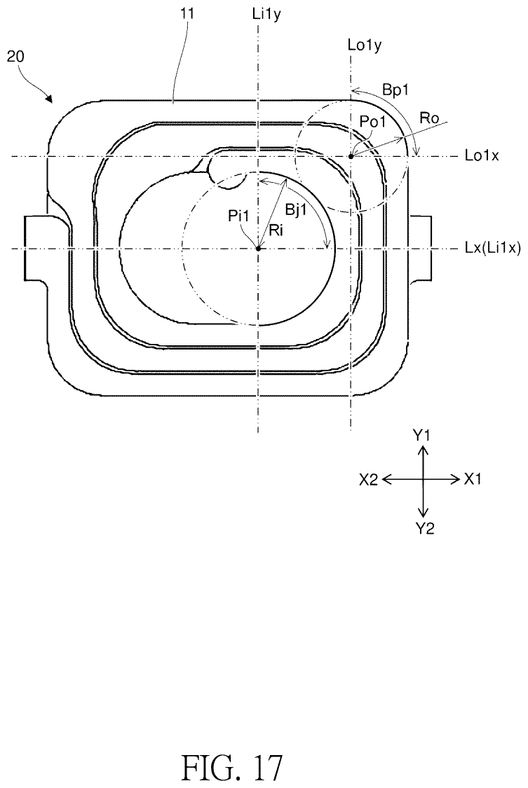

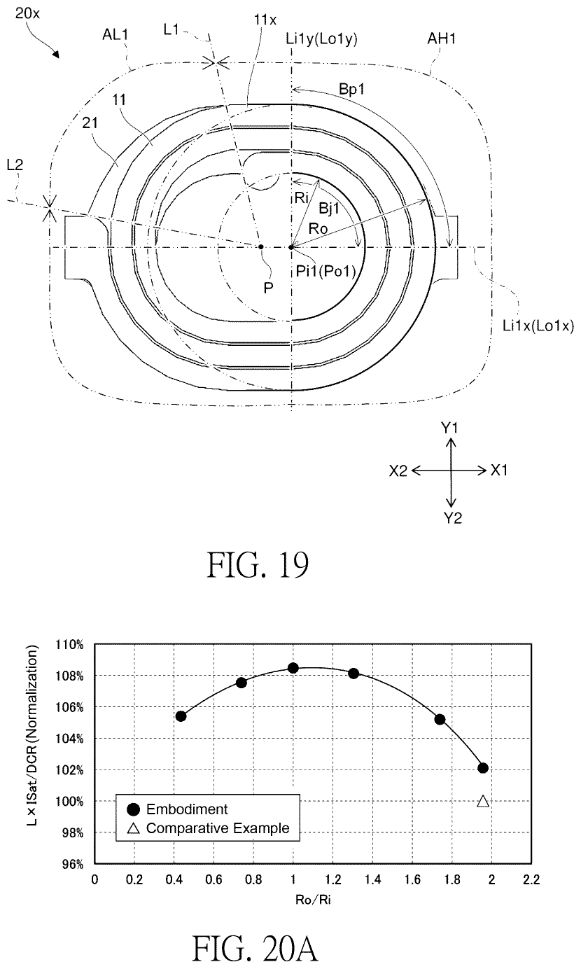

FIGS. 13 to 18C are XY plan views for illustrating the structures of the first and second spiral portions of the coil component according to embodiments of the present invention. FIG. 19 is an XY plan view for illustrating the structures of the first and second spiral portions of the coil component according to a comparative example.

In each embodiment shown in FIGS. 13 to 18C, the shapes of the first spiral portion 11 and the second spiral portion 21 are different. These differences are shown in FIGS. 13 to 18C and Table 1, based on the third feature, with the radius Ri of the approximate arc of the first inner arc portion Bj1 at the inner circumferential edge, and the radius Ro of the approximate arc of the first outer arc portion Bp1 at the outer circumferential edge, as well as the ratio Ro/Ri of radius Ro to radius Ri.

TABLE 1

| Embodiment | 1 | 2 | 3 | 4 | 5 | 6 | Comparative |
|---|---|---|---|---|---|---|---|
| Ri[mm] | 0.23 | 0.23 | 0.23 | 0.23 | 0.23 | 0.23 | 0.23 |
| Ro[mm] | 0.45 | 0.40 | 0.30 | 0.23 | 0.17 | 0.10 | 0.45 |
| Ro/Ri | 1.96 | 1.74 | 1.30 | 1.00 | 0.74 | 0.43 | 1.96 |
| L[uH] | 0.348 | 0.340 | 0.329 | 0.324 | 0.321 | 0.319 | 0.359 |
| DCR[mΩ] | 28.7 | 28.0 | 27.5 | 27.4 | 27.7 | 28.2 | 29.8 |
| Isat[A] | 3.70 | 3.80 | 3.96 | 4.03 | 4.07 | 4.09 | 3.65 |
| L/DCR | 0.0121 | 0.0121 | 0.0120 | 0.0118 | 0.0116 | 0.0113 | 0.0120 |
| L × Isat | 1.29 | 1.29 | 1.30 | 1.31 | 1.31 | 1.31 | 1.31 |
| L × Isat/DCR | 0.0448 | 0.0462 | 0.0474 | 0.0476 | 0.0472 | 0.0462 | 0.0439 |
| Improvement rate | 2.1% | 5.2% | 8.1% | 8.5% | 7.5% | 5.4% | — |

The first spiral portion 11 and the second spiral portion 21 in the comparative example shown in FIG. 19 do not have widening portions. Specifically, the first spiral portion 11 and the second spiral portion 21 in the comparative example are similar to the first spiral portion 11 and the second spiral portion 21 in Example 1, except for the shapes of the first low winding portion AL1 and the second low winding portion AL2 (invisible in FIG. 19). In the first spiral portion 11 in the comparative example, the width of the conductor (turn) of the first low winding portion AL1 is equal to the width of the conductor (turn) of the first high winding portion AH1. Therefore, the width of the first low winding portion AL1, including width of 2 turns, is narrower than the width of the portion of the second spiral portion 21, which faces the first low winding portion AL1, including width of 3 turns. In FIG. 19 viewed from the Z1 side in the Z1-Z2 direction, the portions on the inner circumference and the outer circumference of the first low winding portion AL1, which do not overlap with the first low winding portion AL1 of the second spiral portion 21, are visible.

A simulation is performed on the coil components 100 according to the embodiments and the comparative example. The common dimensions of the coil components 100 are as follows:
‘Main body portion 30: 1.25 mm×1.05 mm×0.45 mm
‘Thickness of coil insulator portion disposed between first spiral portion 11 and second spiral portion 21: 5 μm
‘Conductor (turn) of first spiral portion 11 and second spiral portion 21: width 68 mm, thickness 120 μm’ gap between linear regions of radially adjacent turns in each first spiral portion 11 and each second spiral portion 21: 8 μm (excluding coil insulator portion).

The following features are obtained through simulation:
‘Self-inductance L (unit: μH)
‘DC resistance DCR (unit: mΩ)
‘DC superimposed rated current Isat (unit: A)

In this disclosure, the DC superimposed rated current Isat refers to the current value, at which the self-inductance L decreases by 30% when DC is superimposed.

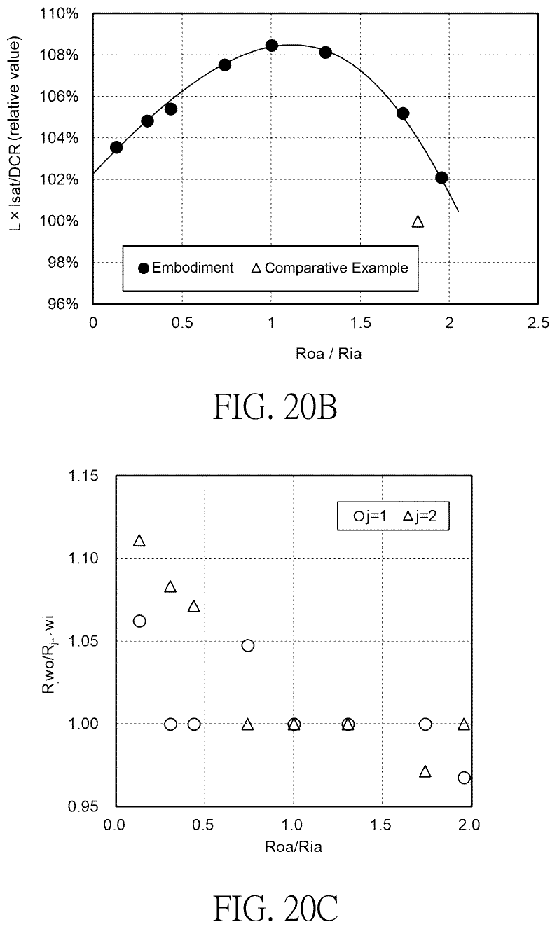

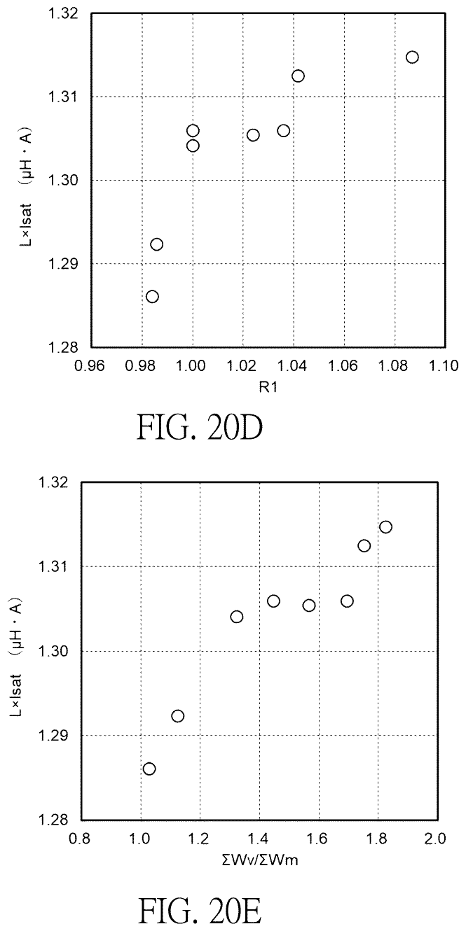

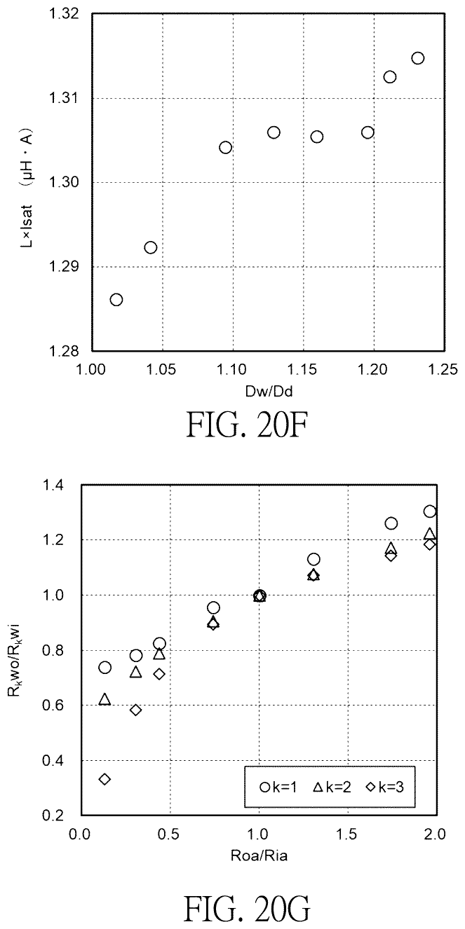

The results of the simulation are shown in Table 1. The improvement rate in Table 1 indicates the degree (unit: %) of improvement in the overall characteristic (L×Isat/DCR) of each embodiment based on the overall characteristic (L×Isat/DCR) of the comparative example. Specifically, the improvement rate is obtained according to {(Overall characteristic of each embodiment-Overall characteristic of the comparative example)/Overall characteristic of the comparative example}×100. The results of Table 1 are shown in the graph of FIG. 20.

As shown in Table 1 and FIG. 20A, the overall characteristic (L×Isat/DCR) is improved by imparting the widening portions to the first spiral portion 11 and the second spiral portion 21. Comparing Embodiment 1 with the comparative example, the overall characteristic (L×Isat/DCR) is increased by 2.1% based on the comparative example.

Furthermore, when the ratio Ro/Ri is 1.0, that is, when the radius Ro and the radius Ri are equal, the overall characteristic (L×Isat/DCR) is the most satisfactory. In order to confirm the characteristics of the embodiments, respectively, Table 2 shows the change rate (unit: %) based on Embodiment 4 with the ratio Ro/Ri being 1.0. Specifically, the change rate of each characteristic is calculated by {(Result of Embodiment-Result of Embodiment 4)/Result of Embodiment 4}×100. As shown in Table 2, the self-inductance L has a tendency to decrease with a decrease in the ratio Ro/Ri, while the Isat has a tendency to increase with a decrease in the ratio Ro/Ri. Furthermore, when the ratio Ro/Ri is 1.0, the DCR is low and the characteristic is the most satisfactory. Therefore, it is considered that the overall characteristic is the best when the ratio Ro/Ri is 1.0 as it reflects the tendency of the DCR, and reaches the largest improvement rate.

TABLE 2

| Embodiment | 1 | 2 | 3 | 4 | 5 | 6 |
|---|---|---|---|---|---|---|
| Ro/RI | 1.96 | 1.74 | 1.30 | 1.00 | 0.74 | 0.43 |
| L change rate | 7.4% | 4.9% | 1.5% | — | −0.9% | 1.5% |
| DOR | 4.6% | 2.0% | 0.2% | — | 0.8% | 2.9% |
| change rate | | | | | | |
| Isat change | −8.3% | −5.7% | −1.7% | — | 0.9% | 1.6% |
| rate | | | | | | |

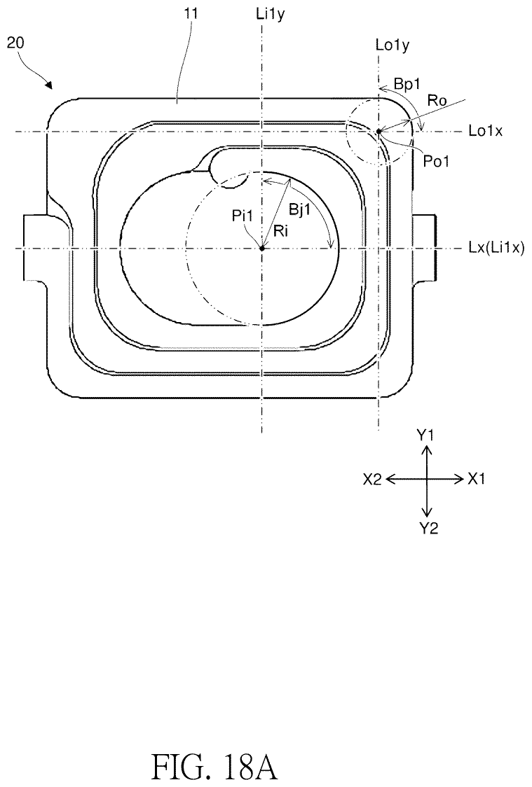

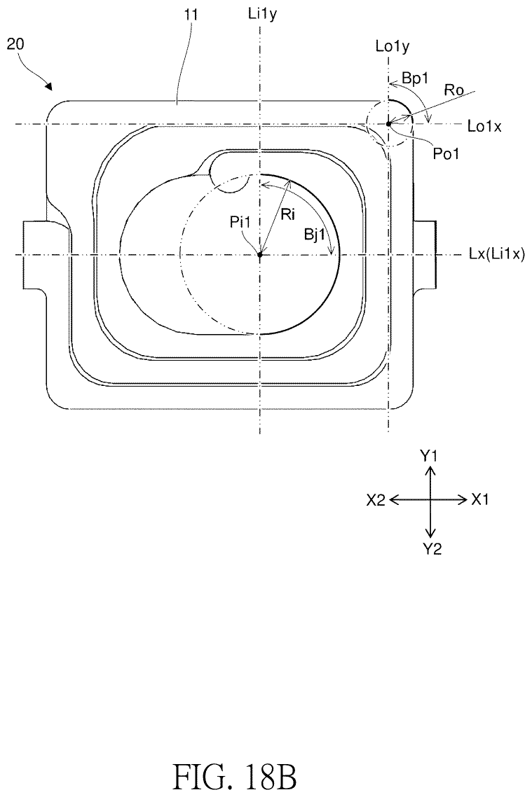

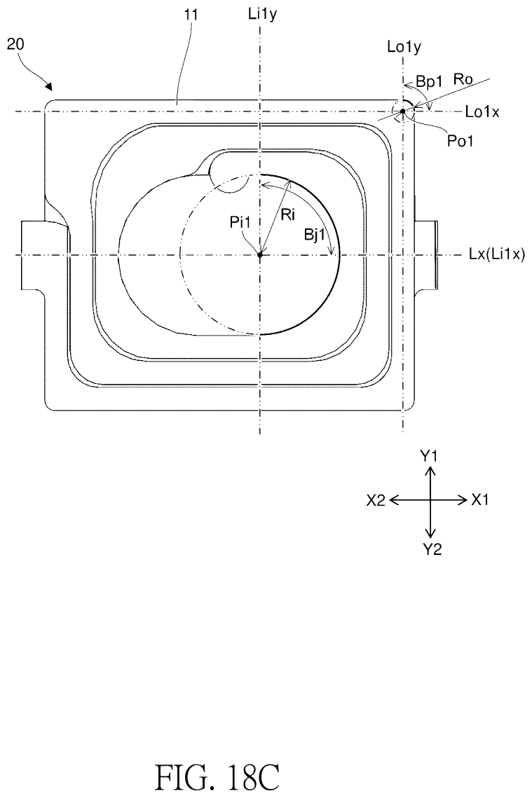

Further simulations are performed with additional embodiments (Embodiment 7 and Embodiment 8), whose shapes are different from the others. The shape of the coil conductor portion 20 in Embodiment 7 is shown in FIG. 18B, and the shape of the coil conductor portion 20 in Embodiment 8 is shown in FIG. 18C. The simulation results of the shape features and characteristics are shown in Table 3. Table 3 includes the data shown in Table 1.

In Table 3, associated with the second feature, Ria is the average of the minimum radius of curvature Rwi of the four inner curved portions, Roa is the average of the minimum radius of curvature Rwo of the four outer curved portions, and Roa/Ria is the ratio of the average Roa to the average Ria. In this example, the ratio RoA/RiA relating to the third feature is equal to the ratio Roa/Ria relating to the second feature. The sum ΣWm and the sum ΣWv, as well as the ratio ΣWv/ΣWm, relate to the eleventh feature. In addition, Wm4′ shown in FIG. 11 is used instead of Wm4 to calculate ΣWm. The distance Dw and the distance Dd, as well as the ratio Dw/Dd, relate to the twelfth feature. R1wi~R3wi and R1wo~R3wo, as well as R1wo/R1wi~R3wo/R3wi, R1wo/R2wi, R2wo/R3wi and R1 relate to the thirteenth and/or fourteenth features.

TABLE 3

| Embodiment | 1 | 2 | 3 | 4 | 5 | 6 | 7 | 8 | comparative |
|---|---|---|---|---|---|---|---|---|---|
| Ri[mm] | 0.23 | 0.23 | 0.23 | 0.23 | 0.23 | 0.23 | 0.23 | 0.23 | 0.23 |
| Ro[mm] | 0.45 | 0.40 | 0.30 | 0.23 | 0.17 | 0.10 | 0.17 | 0.10 | 0.45 |
| Ro/Ri | 1.96 | 1.74 | 1.30 | 1.00 | 0.74 | 0.43 | 0.74 | 0.43 | 1.96 |
| Ria[mm] | 0.23 | 0.23 | 0.23 | 0.23 | 0.23 | 0.23 | 0.23 | 0.23 | 0.24 |
| Roa[mm) | 0.45 | 0.40 | 0.30 | 0.23 | 0.17 | 0.10 | 0.17 | 0.10 | 0.44 |
| Roa/Ria | 1.96 | 1.74 | 1.30 | 1.00 | 0.74 | 0.43 | 0.74 | 0.43 | 1.82 |
| R₁wi | 0.23 | 0.23 | 0.23 | 0.23 | 0.23 | 0.23 | 0.23 | 0.23 | 0.23 |
| R₂wi | 0.31 | 0.29 | 0.26 | 0.23 | 0.21 | 0.19 | 0.18 | 0.16 | 0.31 |
| R₃wi | 0.38 | 0.35 | 0.28 | 0.23 | 0.19 | 0.14 | 0.12 | 0.09 | 0.38 |
| R₁wo | 0.30 | 0.29 | 0.26 | 0.23 | 0.22 | 0.19 | 0.18 | 0.17 | 0.30 |
| R₂wo | 0.38 | 0.34 | 0.28 | 0.23 | 0.19 | 0.15 | 0.13 | 0.10 | 0.38 |
| R₃wo | 0.45 | 0.40 | 0.30 | 0.23 | 0.17 | 0.10 | 0.07 | 0.03 | 0.45 |
| R₁wo/R₁wi | 1.30 | 1.26 | 1.13 | 1.00 | 0.96 | 0.83 | 0.78 | 0.74 | 1.30 |
| R₂wo/R₂wi | 1.23 | 1.17 | 1.08 | 1.00 | 0.90 | 0.79 | 0.72 | 0.63 | 1.23 |
| R₃wo/R₃wi | 1.18 | 1.14 | 1.07 | 1.00 | 0.89 | 0.71 | 0.58 | 0.33 | 1.18 |
| R₁wo/R₂wi | 0.97 | 1.00 | 1.00 | 1.00 | 1.05 | 1.00 | 1.00 | 1.06 | 0.97 |
| R₂wo/R₃wi | 1.00 | 0.97 | 1.00 | 1.00 | 1.00 | 1.07 | 1.08 | 1.11 | 1.00 |
| R1 | 0.984 | 0.986 | 1.000 | 1.000 | 1.024 | 1.036 | 1.042 | 1.087 | 0.984 |
| ΣWm[mm] | 0.880 | 0.880 | 0.880 | 0.880 | 0.880 | 0.880 | 0.880 | 0.880 | 0.880 |
| ΣWv[mm] | 0.904 | 0.989 | 1.163 | 1.273 | 1.378 | 1.490 | 1.542 | 1.606 | 0.904 |
| ΣWv/ΣWv | 1.03 | 1.12 | 1.32 | 1.45 | 1.57 | 1.69 | 1.75 | 1.83 | 1.03 |
| Dd[mm] | 0.408 | 0.408 | 0.408 | 0.408 | 0.408 | 0.408 | 0.408 | 0.408 | 0.408 |
| Dw[mm] | 0.415 | 0.425 | 0.446 | 0.460 | 0.473 | 0.488 | 0.494 | 0.502 | 0.417 |
| Dw/Dd | 1.02 | 1.04 | 1.09 | 1.13 | 1.16 | 1.20 | 1.21 | 1.23 | 1.02 |
| L[uH] | 0.348 | 0.340 | 0.329 | 0.324 | 0.321 | 0.319 | 0.320 | 0.320 | 0.359 |
| DCR[mΩ] | 28.7 | 28.0 | 27.6 | 27.4 | 27.7 | 28.2 | 28.5 | 28.9 | 29.8 |
| Isat[A] | 3.70 | 3.80 | 3.96 | 4.03 | 4.07 | 4.09 | 4.11 | 4.11 | 3.65 |
| L/DCR | 0.0121 | 0.0121 | 0.0120 | 0.0118 | 0.0116 | 0.0113 | 0.0112 | 0.0110\| | 0.0120 |
| L × Isat | 1.286 | 1.292 | 1.304 | 1.306 | 1.305 | 1.306 | 1.313 | 1.315 | 1.309 |
| L × Isat/DCR | 0.0448 | 0.0462 | 0.0474 | 0.0476 | 0.0472 | 0.0462 | 0.0460 | 0.0454 | 0.0439 |
| Improvement rate | 2.1% | 5.2% | 8.1% | 8.5% | 7.5% | 5.4% | 4.8% | 3.6% | — |

FIG. 20B is a graph showing the results of the embodiments and the comparative example (Roa/Ria dependence of overall characteristic (L×Isat/DCR)). FIG. 20C is a graph showing the results of the embodiments (relationship between Rjwo/Rj+1Wi and Roa/Ria). FIG. 20D is a graph showing the results of the embodiments (R1 dependence of L×Isat). FIG. 20E is a graph showing the results of the embodiments (ΣWv/ΣWm dependence of L×Isat). FIG. 20F is a graph showing the results of the embodiments (Dw/Dd dependence of L×Isat). FIG. 20G is a graph showing the results of the embodiments (relationship between Rkwo/RkWi and Roa/Ria).

As shown in Table 3, Ri and Ria, Ro and Roa, and Ro/Ri and Roa/Ria are equal except for the comparative example that does not have a widening portion. Therefore, as shown in FIG. 20B, the substantial tendency of the dependency of the overall characteristic (L×Isat/DCR) on Roa/Ria is the same as the dependency of the overall characteristic (L×Isat/DCR) on Ro/Ri, and when Roa/Ria is from 0.8 to 1.3, the overall characteristic (L×Isat/DCR) is particularly satisfactory.

As shown in FIGS. 20D to 20F, L×Isat has a positive correlation with each of R1, ΣWv/ΣWm, and Dw/Dd. Therefore, when the self-inductance L of the coil component 100 is predetermined in consideration of requirements of circuitry, the coil component 100 should be set to be a specific shape so that these parameters can be enhanced. Specifically, by approximating the shape of the coil component to a rectangle when viewed in the first direction (Z1-Z2 direction), more current can flow in the coil component 100.

The above-described embodiments and examples are described to facilitate understanding of the present invention, and are not described to limit the present invention. Therefore, each element disclosed in the above embodiments is intended to include all design modifications and equivalents that fall within the technical scope of the present invention. For example, the first spiral portion 11 may not have any features other than the first feature, or may not have one or more of the first to fifth features, the seventh to ninth features, the tenth feature, and the twelfth to fifteenth features. The second spiral portion 21 may not satisfy all of the first to fifth features, the seventh to ninth features, the tenth feature, and the twelfth feature, or may satisfy at least one of them. Since the second spiral portion 21 has a basic shape in common with the first spiral portion 11, it may satisfy at least one of the features corresponding to the eleventh feature to the fifteenth feature.

In the above embodiments, the coil component 100 has two spiral portions (first spiral portion 11, second spiral portion 21), but it may alternatively have only the first spiral part 11 having the first to fifth features, the seventh to ninth features, the tenth feature, and the twelfth feature.

The coil component 100 may have three or more spiral portions. In this case, it is preferable to set the spiral direction of all the spiral portions so that a unidirectional magnetic field in the first direction (Z1-Z2 direction) is generated inside the inner circumference of the coil component 10 when a current is passing through the coil component 100. Furthermore, it is preferable that at least one, and preferably all, of the three or more spiral portions satisfy the above first feature, and it is more preferable that they further have at least one of the second to twelfth features. When the coil component has three or more spiral portions, a via member VP is provided at each of the two ends of the spiral portion, where other spiral portions are arranged on both sides in the first direction.

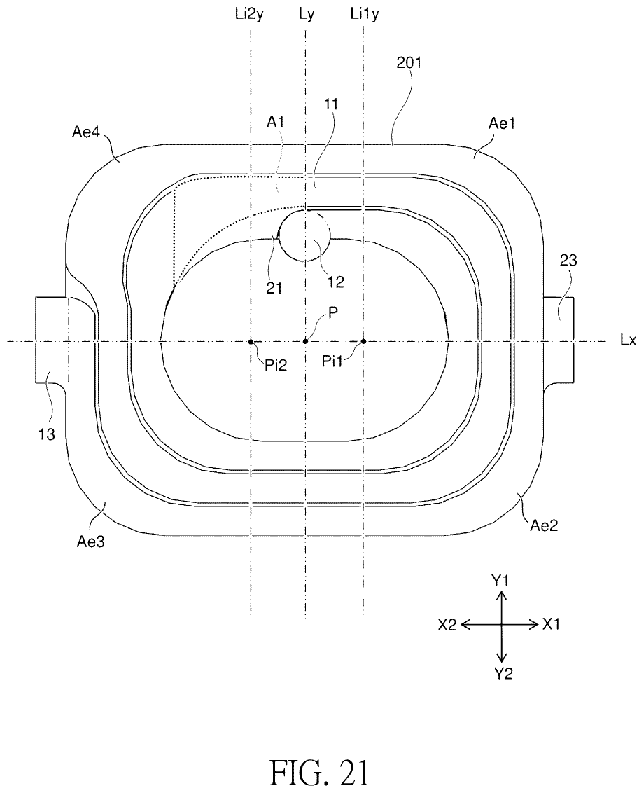

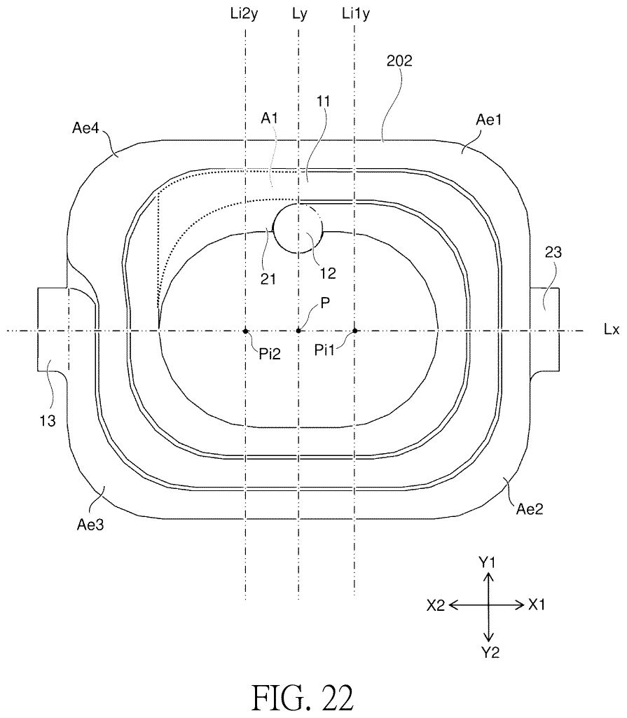

As shown in FIG. 10, the first spiral portion 11 included in the coil conductor portion 20 of the coil component 100 according to this embodiment has a region A1 where the width of the conductor widens, but the specific shape in this region A1 is not limited to the structure shown in FIG. 10. For example, as in the coil conductor portion 201 shown in FIG. 21 and the coil conductor portion 202 shown in FIG. 22, the width of the conductor may widen gradually, with the result that the region A1 widens in the direction opposite the spiral direction (the X2 side in the X1-X2 direction, and the Y1 side in the Y1-Y2 direction). In addition, the turn of the first spiral portion 11 adjacent to the end part 12 via a gap may have a widening portion to accommodate at least a part of the end part 12.

### DESCRIPTIONS OF REFERENCE NUMERALS

100: coil component
10: coil member
20, 20x, 201, 202: coil conductor portion
11, 11x: first spiral portion
11ap, 30ap: approximate rectangle
12, 22: one end part
13, 23: another end part
21: second spiral portion
30: main body portion
41: first terminal member
41a: side portion
41b: bottom portion
42: second terminal member
42a: side portion
42b: bottom portion
50, 60: outer cover
111: first turn
112: second turn
112B: curved region
112L1, 112L2: line segment
112S: linear region
113: third turn
A1, A2: region
AH1: first high winding portion
AH2: second high winding portion
AL1: first low winding portion
AL2: second low winding portion
Ae1~Ae4: first widening portion to fourth widening portion
Bli: first-turn inner curved portion
Blo: first-turn outer curved portion
B21: second-turn inner curved portion
B20: second-turn outer curved portion
B3i: third-turn inner curved portion
B30: third-turn outer curved portion
Bc1-Bc4: first linear connecting region to fourth linear
connecting region
Bi1~Bi2: first inner curved portion to second inner curved portion
Bj1~Bj4: first inner arc portion to fourth inner arc portion
Bo1~Bo4: first outer curved portion to fourth outer curved portion
Bp1~Bp4: first outer arc portion to fourth outer arc portion
Ci1, Ci2: semicircle arc
Co1~Co4: quarter circle
Di1~Di4, Do1~Do4: arc length
Dd, Dw: distance
G1, G2, G112, G123, G212, G223, G12b, G12s, G23, G23b, G23s: gap
L1~L5, Le3, Li1x, Li1x, Lily, Lo1x, Lo1y, Lo2x, Lo2y, Lx, Ly: virtual line
M1~M4, Mc1~Mc4: midpoint
O: axis
P, P1i~P3i, P1o~P30, Po1~Po4, Pd1~Pd4, Pw1~Pw4, Qi0~Oi7, Qo1~Qo3, So1~So8, Ti1~Ti4: point
R1wi~R3wi, R1wo~R3wo, Rwi, Rwo: minimum radius of curvature
Ri, Ro: radius
V1~V4, Vc1~Vc4: vertex
VP: via member
Wn, We1~We4: width
Wm1~Wm4, Wm4′, Wv1~Wv4, Wmc1~Wmc4, Wvc1~Wvc4: length
θ1: inclination
θi1~θi4, θo1-θo4: central angle

1. A coil component, comprising:
a coil member having a coil conductor portion, which comprises a first spiral portion of a spiral shape when viewed in a first direction; and
terminal members electrically connected to two end parts of the coil conductor portion, respectively;
wherein, when viewed in the first direction, the first spiral portion comprises a widening portion, so that a width of the first spiral portion increases and then decreases along a spiral direction of the first spiral portion.

2. The coil component according to claim 1, further comprising a main body portion containing a magnetic powder, wherein:
the coil member further comprises a coil insulator portion on a surface of the coil conductor portion;
the coil conductor portion further comprises a second spiral portion of a spiral shape when viewed in the first direction, and a via member electrically connected to the first spiral portion and the second spiral portion;
the coil insulator portion is disposed between the first spiral portion and the second spiral portion, and for enabling contact of one end part of the first spiral portion with one end part of the second spiral portion in the first direction, the via member is disposed between the one end part of the first spiral portion and the one end part of the second spiral portion.

3. The coil component according to claim 1, wherein, when viewed in the first direction, an inner circumferential edge of the first spiral portion comprises an inner curved portion having a radius of curvature, which decreases and then increases; an outer circumferential edge of the first spiral portion comprises an outer curved portion having a radius of curvature, which decreases and then increases; the outer curved portion is opposite to the inner curved portion with the first spiral portion clamped in between; and there are four or more sets of the inner curved portion and the outer curved portion, and a ratio Roa/RiA of an average Roa of minimum radii of curvature Rwo of the outer curved portions to an average Ria of minimum radii of curvature Rwi of the inner curved portions is from 0.80 to 1.30.

4. The coil component according to claim 1, wherein, when viewed in the first direction, an inner circumferential edge of the first spiral portion comprises an inner arc portion, which is shaped approximately as an arc having a radius Ri and a central angle of 90°; an outer circumferential edge of the first spiral portion comprises an outer arc portion, which is shaped approximately as an arc having a radius Ro and a central angle of 90°, and a connecting portion, which is shaped approximately as an arc having a radius larger than the radius Ro or a straight line; and there are four sets of the inner arc portion and the outer arc portion, and four ones of the connecting portion, and a ratio RoA/RiA of an average RoA of radii Ro of the outer arc portions to an average RiA of radii Ri of the inner arc portions is from 0.80 to 1.30.

5. The coil component according to claim 1, wherein:
the first spiral portion comprises a plurality of turns when viewed in the first direction, and comprises a first region having a relatively large number of turns, and a second region having a relatively small number of turns, and there are n turns (n is a natural number of 2 or more) in the first region;
the turn located in the innermost side of the first region is defined as a first turn, the turn located in the outermost side of the first region is defined as an nth turn, the turns located in the first region are defined so as to be distinguishable from each other, and j is a natural number equal to or smaller than n−1;
an outer circumferential edge of a jth turn comprises a jth-turn outer curved portion, the jth-turn outer curved portion having a decreasing and then increasing radius of curvature;
an inner circumferential edge of a (j+1)th turn, which is opposite to the outer circumferential edge of the jth turn, and comprises a (j+1)th-turn inner curved portion, the (j+1)th-turn inner curved portion having a decreasing and then increasing radius of curvature; and
there exists at least one j satisfying a condition of Rjwo/Rj+1wi≥0.9, where Rwo is a minimum radius of curvature of the jth-turn outer curved portion, and Rj+1wi is a minimum radius of curvature of the (j+1)th-turn inner curved portion.

6. The coil component according to claim 1, wherein:
the first spiral portion comprises a plurality of turns when viewed in the first direction, and comprises a first region having a relatively large number of turns, and a second region having a relatively small number of turns, and there are n turns (n is a natural number of 2 or more) in the first region;
the turn located in the innermost side of the first region is defined as a first turn, the turn located in the outermost side of the first region is defined as an nth turn, the turns located in the first region are defined so as to be distinguishable from each other, and k is a natural number equal to or smaller than n;
an outer circumferential edge of a kth turn comprises a kth-turn outer curved portion, the outer curved portion having a decreasing and then increasing radius of curvature;
an inner circumferential edge of a kth turn comprises a kth-turn inner curved portion, the inner curved portion having a decreasing and then increasing radius of curvature; and
each k satisfies a condition of Rkwo/Rkwi is from 0.8 to 1.2, where Rkwo is a minimum radius of curvature of the kth-turn outer curved portion, and Rkwi is a minimum radius of curvature of the kth-turn inner curved portion.

7. The coil component according to claim 1, wherein the first spiral portion comprises a plurality of turns when viewed in the first direction, and comprises a first region having a relatively large number of turns, and each of the first region and the second region comprises the widening portion.

8. The coil component according to claim 2, wherein:
the first spiral portion comprises a plurality of turns when viewed in the first direction, and comprises a first region having a relatively large number of turns, and a second region having a relatively small number of turns, and each of the first region and the second region comprises the widening portion, and
the second spiral portion comprises a plurality of turns when viewed in the first direction, and comprises a third region having a relatively large number of turns, and a fourth region having a relatively small number of turns, and each of the third region and the fourth region comprises the widening portion.

9. The coil component according to claim 2, wherein a turn of the first spiral portion, which is immediately adjacent to the one end part of the first spiral portion via a gap, comprises the widening portion to accommodate at least a portion of the one end part of the first spiral portion.

10. The coil component according to claim 2, wherein a turn of the first spiral portion, which is immediately adjacent to the one end part via a gap, comprises the widening portion disposed at a position just passing the one end part in the direction opposite to the spiral direction, which starts from the one end part.

11. The coil component according to claim 2, wherein a turn of the first spiral portion, which is immediately adjacent to an outermost turn of the first spiral portion via a gap, comprises the widening portion disposed at a position just passing the outermost turn along the spiral direction, which starts from the one end part.

12. The coil component according to claim 2, wherein:
the first spiral portion comprises a plurality of turns when viewed in the first direction, and comprises a first region having a relatively large number of turns, and a second region having a relatively small number of turns,
the second spiral portion comprises a second specified number of turns when viewed in the first direction, and comprises a third region having a relatively large number of turns, and a fourth region having a relatively small number of turns,
a gap between turns of the first spiral portion and a gap between turns of the second spiral portion sandwich the coil insulator portion and form an opposing portion, and
a gap in the second region and a gap in the fourth region sandwich the coil insulator portion and intersect.

13. The coil component according to claim 2, wherein, when viewed in the first direction, an outer shape of the main body portion is approximately a rectangle, and a sum of lengths of the first spiral portion on two diagonals of the rectangle is greater than a sum of lengths of the first spiral portion on two line segments, each connecting midpoints of two opposite sides of the rectangle.

14. The coil component according to claim 2, wherein, when viewed in the first direction, an outer shape of the main body portion is approximately a rectangle, and a midpoint of the first spiral portion on each of two diagonals of the rectangle is disposed closer to a vertex than a midpoint between an intersection point of the two diagonals and the vertex of the rectangle is.

15. The coil component according to claim 1, wherein, when viewed in the first direction, and when an outer shape of the first spiral portion is approximately a rectangle, at least one of lengths of the first spiral portion on two diagonals of the rectangle is greater than at least one of lengths of the first spiral portion on two line segments, each connecting midpoints of two opposite sides of the rectangle.

16. The coil component according to claim 15, further comprising a main body portion, which is shaped as an approximate rectangle when viewed in the first direction and comprises a magnetic powder, wherein:
when viewed in the first direction, two diagonals of the approximate rectangle of the outermost circumferential edge of the first spiral portion extend along with two diagonals of the approximate rectangle of the outer shape of the main body portion.

17. An electronic/electric device, installed therein the coil component according to claim 1, wherein the coil component is connected to a board via the terminal members.
